(19) United States
(12) Patent Application Publication
(10) Pub. No.: US 2024/0265402 A1
(43) Pub. Date: Aug. 8, 2024

(54) FAST RELEASE OF INGESTIBLE PRODUCTS

(71) Applicant: Novolyze Inc., Cambridge, MA (US)

(72) Inventors: Karim-Franck Khinouche, Washington, DC (US); Jérôme Defillon, Heudebouville (FR); Pierre-Alexandre Juan, Tart (FR); Laure Pujol, Seurre (FR)

(21) Appl. No.: 18/105,072

(22) Filed: Feb. 2, 2023

(51) Int. Cl. G06Q 30/018; G06Q 10/0639

(52) U.S. Cl. CPC G06Q 30/018; G06Q 10/06393; G06Q 10/20

(57) ABSTRACT

Provided herein are techniques, devices, and systems for determining the releasability of an ingestible product to enable fast release of the ingestible product from a facility where the ingestible product is processed. A computing system may receive data associated with different steps of a production process associated with an ingestible product. Based on the data, the computing system may determine a metric associated with the ingestible product, the metric indicative of a probability of the ingestible product being ready to be released from a processing facility. Based on the metric, the computing system may cause information to be output via a user device, wherein the information indicates whether the ingestible product is ready to be released from the processing facility.

### BACKGROUND

Food processing entities operate facilities where food products are processed. Before food products are released from these facilities, the food products are inspected to confirm that they meet various standards, such as safety standards, quality standards, and the like. Such inspections are typically performed on food product samples at random, and the results of the inspection are typically printed on paper for review by a human inspector. The disclosure made herein is presented with respect to these and other considerations.

### BRIEF DESCRIPTION OF THE DRAWINGS

FIG. 1 illustrates an example platform including an example computing system configured to determine whether an ingestible product is ready to be released from a processing facility.

FIG. 2 illustrates data being collected in association with different steps of a production process carried out at a processing facility to produce an ingestible product.

FIG. 3A illustrates an example user interface presenting information that includes a recommendation to redirect an ingestible product to a different end usage.

FIG. 3B illustrates another example user interface presenting information indicating that an ingestible product is releasable under one or more conditions.

FIG. 4 is a flow diagram of an example process for outputting, via a user device, information indicating whether an ingestible product is ready to be released from a processing facility.

FIG. 5 illustrates a flow diagram of an example process for retraining a trained machine learning model(s) based on feedback received from a user who is authorized to release ingestible products from a processing facility.

FIG. 6 is a flow diagram of an example process for outputting, via a user device, information that includes a recommendation for salvaging an ingestible product if a releasability metric associated with the ingestible product fails to satisfy a threshold.

FIG. 7 is a flow diagram of an example process for triaging a raw ingestible product based on releasability metrics determined before an ingestible product is produced with the raw ingestible product, and for retraining a trained machine learning model based on releasability metrics determined before and after the ingestible product is produced.

FIG. 8 is a computer architecture diagram showing an illustrative computer architecture for implementing a computing device(s) that can be utilized to implement aspects of the various technologies presented herein.

### DETAILED DESCRIPTION

Described herein are, among other things, techniques, devices, and systems for determining the releasability of an ingestible product to enable fast release of the ingestible product from a facility where the ingestible product is processed. In some examples, the ingestible product may be a food product. In these examples, a food processing entity may operate a facility where a food product is processed for customers. The customers, in turn, may use the processed food product, process the food product further, and/or provide the processed food product to downstream customers, such as end consumers (e.g., the general public). Initially, a raw (or unprocessed) food product may be delivered to the facility, and the raw food product may be processed within the facility to produce the food product (or processed food product). A food production process may include multiple different steps from a time at which the raw food product is delivered to the facility to a time at which the food product is released from the facility. By way of example, and not limitation, upon delivery of the raw food product, the raw food product may be stored (e.g., in a temperature-controlled intake storage room of the facility) until it is processed within the facility. Processing the food product may include, among other things, cutting, grinding, and/or pulverizing the food product, introducing one or more ingredients into the food product, removing one or more ingredients from the food product, heating and/or cooling the food product, treating (e.g., heat treating, such as by cooking, chemically treating, pressurizing, irradiating, etc.) the food product to kill a pathogen(s), or the like. In some examples, after completing the food production process, the food product may again be stored (e.g., in a temperature-controlled output storage room of the facility) before the food product is released from the facility. A food production process may include some, or all, of these steps, and, in some examples, a food production process may include other steps, such as steps of performing maintenance on food processing equipment (e.g., fixing, calibrating, and/or cleaning (e.g., sanitizing) the equipment) in between production runs.

The techniques, devices, and systems described herein provide a platform that is configured to receive data associated with different steps of a food production process associated with a food product, and to determine, based at least in part on the data, a metric associated with the food product. This metric (sometimes referred to herein as a “releasability metric”) may be indicative of a probability of the food product being ready to be released from the food processing facility. For example, the data may include, among other data, contaminant data indicating a level of a contaminant(s) (e.g., a microbial contaminant(s), a chemical contaminant(s), a physical contaminant(s), etc.) detected in the food product. In this example, the releasability metric may be indicative of whether the food product meets a safety standard in order to be safe for consumption, and, hence, ready for release from the facility. It is to be appreciated, however, that the data used to determine the releasability metric may include other non-safety-related data, such as data (e.g., food data) indicating a characteristic(s) (e.g., color, smell, texture, moisture level, etc.) of the food product, packaging data indicating a characteristic(s) of packaging for the food product, labeling data indicating a characteristic(s) of labeling for the food product, environmental data indicating a value(s) of an environmental parameter(s) (e.g., temperature, humidity, altitude, etc.) associated with the food processing facility, storage data indicating a storage condition(s) (e.g., temperature, humidity, duration, etc.) of the food product, maintenance data indicating a maintenance action(s) performed on food processing equipment in the facility, or the like. Some or all of this data may be used to determine whether the food product meets various standards and/or criteria for release from the facility, such as a quality standard, a packaging standard, a labeling standard, etc. As such, the data can be processed in the various ways described herein to determine the releasability metric for the food product.

The disclosed platform is further configured to cause information to be output via a user device based at least in part on the releasability metric, the information indicating whether the food product is ready to be released from the food processing facility. Accordingly, a user of the user device who is viewing the information is able to make an informed decision as to whether to authorize the release of the food product from the facility, or to otherwise hold, discard, and/or redirect the food product to a different end usage. Because data associated with various steps (or stages) of a food production process is gathered automatically (e.g., using equipment, such as devices, distributed about the food processing facility), and because the data is processed to determine a releasability metric that is easily understandable and that is made readily available to an authorized user, the disclosed platform enables the authorized user to make a decision to release the food product in a reduced amount of time, as compared to conventional processes for releasing food products from food processing facilities. That is, the techniques, devices, and systems described herein enable fast release of a food product from a facility where the food product is processed. This time savings, in turn, results in optimizing the processes that are carried out within a food processing facility to achieve, among other things, higher yield of the food product and/or a lower carbon footprint. That is, resources, such as power resources (e.g., energy), processing resources, memory resources, networking resources, and the like, may be conserved by aspects of the techniques and systems described herein. For example, if the disclosed platform determines that a food product is ready to be released, and if food release data associated with the food product indicates that there is room for reducing the consumption of resources within the facility without compromising the releasability of the food product for future production runs, a food processing entity can use the food release data to optimize the food production process (e.g., to process food more efficiently), thereby reducing the environmental impact of processing the food product within the facility through energy conservation and other resource conserving techniques.

The techniques, devices, and systems described herein also allow for determining whether a food product is ready to be released from a facility based on data that is representative of the entire quantity (e.g., batch) of food product, as compared to data that merely represents a random sample (i.e., a small fraction) of the food product that is produced within the facility. For example, by collecting data from various sources and/or equipment distributed about the food processing facility, and by collecting data that is associated with multiple different steps of a food production process, the collected data is comprehensive in that it provides the “big picture” regarding the provenance of the food product (e.g., where it came from and what happened to it at each step along the way). This enables an assessment of whether more than just a safety standard is met by the entire food product, and the assessment is representative of the entire quantity of the food product, as opposed to a random sample thereof.

The techniques, devices, and systems described herein also provide a reliable system for the retention of food release data, at least some of which allows a food processing entity to easily produce the requisite evidence of compliance with various standards, such as safety standards, quality standards, packaging standards, labeling standards, and the like. This evidence is producible, on demand, for ensuring that customers receive a quality food product that meets their quality standards, and/or for proving, to food safety regulating bodies, such as the Food and Drug Administration (FDA) in the United States, that a food product is safe and/or that the food product is labeled correctly (e.g., labeled with the correct allergen information).

It should be appreciated that the subject matter presented herein can be implemented as a computer process, a computer-controlled apparatus, a computing system, or an article of manufacture, such as a computer-readable storage medium. While the subject matter described herein is presented in the general context of program modules that execute on one or more computing devices, those skilled in the art will recognize that other implementations can be performed in combination with other types of program modules. Generally, program modules include routines, programs, components, data structures, and other types of structures that perform particular tasks or implement particular abstract data types.

Those skilled in the art will also appreciate that aspects of the subject matter described herein can be practiced on or in conjunction with other computer system configurations beyond those described herein, including multiprocessor systems, microprocessor-based or programmable consumer electronics, minicomputers, mainframe computers, handheld computers, personal digital assistants, mobile telephone devices, tablet computing devices, special-purposed hardware devices, network appliances, and the like. The configurations described herein can be practiced in distributed computing environments, such as a service provider network, where tasks can be performed by remote computing devices that are linked through a communications network. In a distributed computing environment, program modules can be located in both local and remote memory storage devices.

In the following detailed description, references are made to the accompanying drawings that form a part hereof, and that show, by way of illustration, specific configurations or examples. The drawings herein are not drawn to scale. Like numerals represent like elements throughout the several figures (which might be referred to herein as a “FIG.” or “FIGS.”).

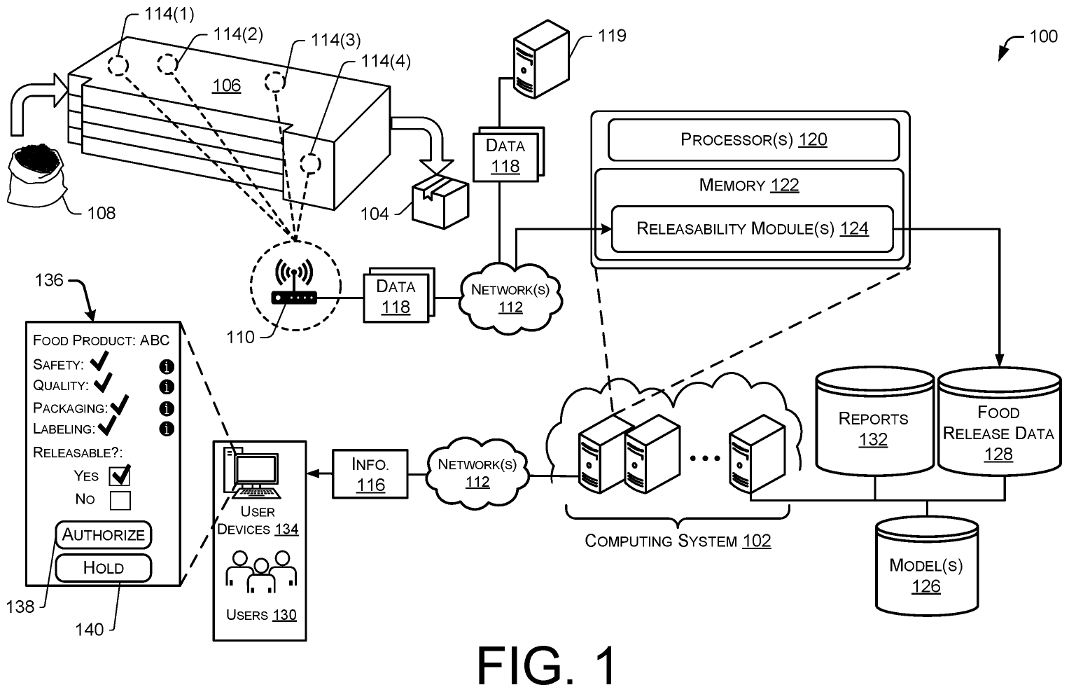

FIG. 1 illustrates an example platform 100 including an example computing system 102 configured to determine whether an ingestible product 104 is ready to be released from a food processing facility 106. The ingestible product 104 is often referred to herein as a “food product 104” to denote food that is ingestible. However, it is to be appreciated that the ingestible product 104 is not limited to food despite numerous references to “food product 104” herein. FIG. 1 depicts a facility 106, which may represent a processing facility 106 where a food product 104 is processed. The types of food products 104 that are processed within the facility 106 may vary, and it is to be appreciated that the food product 104 processed within the food processing facility 106 can be any suitable type of food product, such as a meat product, a vegetable product, a fruit product, a dairy product, a beverage product, a grain-based food product (e.g., cereal, snack bars, etc.), a dessert product, a food ingredient (e.g., flour, sugar, cocoa, etc.), or the like. It is also to be appreciated that a food product may be in solid form, liquid form, including powders, flours, or any other suitable form. As such, the term “food product” can mean beverages or drinks, in some examples.

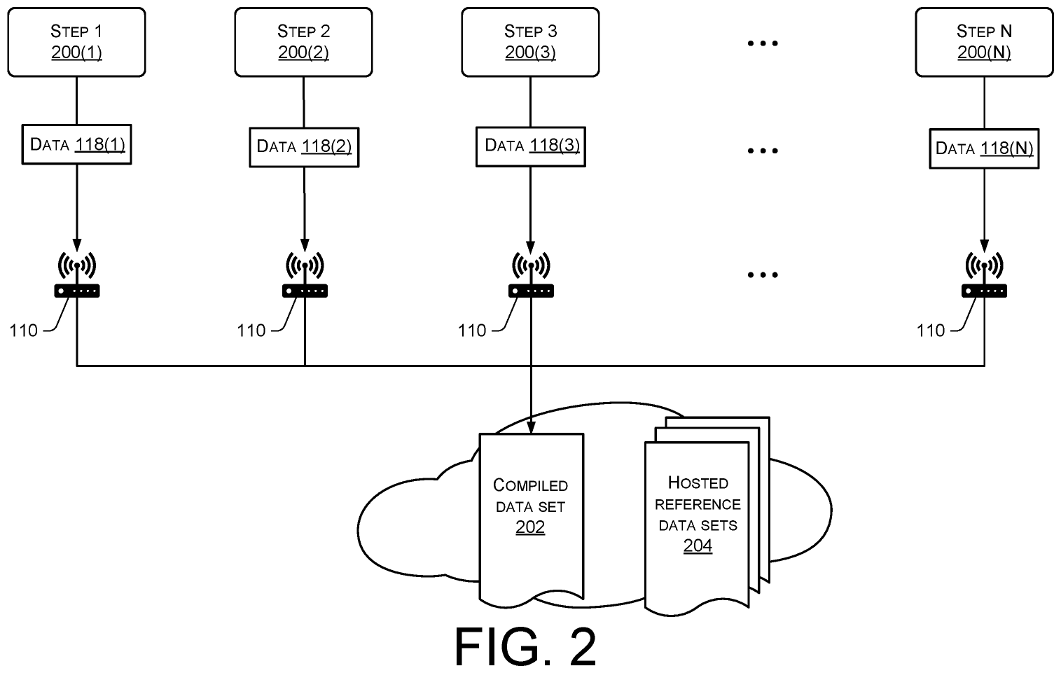

The food product 104 may be “processed” within the facility 106 in a variety of ways, such as by cutting, grinding, and/or pulverizing the food product 104, introducing one or more ingredients into the food product 104 (e.g., mixing the food product 104 with water, oil, spices, preservatives, etc.), removing one or more ingredients from the food product 104 (e.g., removing water, caffeine, etc. from the food product 104), heating (e.g., melting, cooking, etc.) and/or cooling the food product 104, packaging the food product 104, labeling the food product 104 and/or the packaging, or the like. In the example of FIG. 1, a raw (or unprocessed) food product 108 is delivered to the facility 106, and the raw food product 108 is processed within the facility 106 using any of the steps noted above and/or other steps, to obtain the food product 104 (or processed food product), which is shown in FIG. 1 as a packaged food product 104. In general, a food production process (or production process) may include multiple different steps 200(1) to 200(N) (See FIG. 2) that are performed from a time at which the raw food product 108 is delivered to the facility 106 to a time at which the food product 104 is released from the facility 106. Accordingly, the steps 200 of the food production process may include processing the food product 104 in the various ways described above and/or in other ways known to a person having ordinary skill in the art.

In some examples, one or more of the steps 200 of the food production process include storing the raw food product 108 and/or storing a partially- or fully-processed food product 104. Example conditions of such storage may include a temperature at which the food product is stored, a humidity of the storage environment, a duration over which the food product is stored, and ambient light level of the storage environment, and/or other storage conditions. In some examples, one or more of the steps 200 of the food production process include packaging the food product 104, labeling the food product 104 (and/or its package), or the like. In some examples, one or more of the steps 200 of the food production process include performing maintenance on food processing equipment (or processing equipment), such as fixing, calibrating, and/or cleaning (e.g., sanitizing) the equipment in between production runs.

The food product 104 may be at risk of contamination from a contaminant(s), either before the food product 104 is processed within the facility 106 (e.g., after harvesting, while in a holding facility, and/or during transport to the facility 106), or during processing of the food product 104 within the facility. An example of a contaminant is a pathogen. A “pathogen,” as used herein, can be a bacterium, a virus, or another organism (e.g., a parasite) or microorganism (e.g., a microbe) that can cause disease. Consumers who ingest food that is contaminated with a pathogen may get food poisoning, which can manifest in one or more symptoms, such as cramping, nausea, vomiting, diarrhea, or the like. While food poisoning can be mild, some foodborne diseases may result in hospitalization and/or death. It is to be appreciated, however, that the term “contaminant,” as used herein, is not limited to pathogens. As such, the term “contaminant” can mean microbial contaminant, chemical contaminant, physical contaminant, or the like. Examples of physical contaminants include metals and plastics. Examples of chemical contaminants include pesticides, mercury, residue from chemical products used for sanitizing equipment and/or surfaces, such as chlorinated products, peracetic acid products, or the like. Example pathogens include Salmonella, Clostridium perfringens, Campylobacter, Staphylococcus aureus, Escherichia coli, Listeria monocytogenes, Norovirus, Toxoplasma gondii, or any other known or heretofore undiscovered pathogen. In some examples, one or more of the steps 200 of the food production process may include using contaminant detectors to detect contaminants in the raw food product 108 and/or the partially- or fully-processed food product 104, and/or treating the food product 104 in order to “kill” (e.g., reduce an amount of) a pathogen(s) of interest within the food product 104 as part of a “kill step.” Such treatment may represent, or include, heat treatment, chemical treatment, pressure treatment (e.g., pressurizing), irradiation treatment, such as light (e.g., ultraviolet (UV) light) treatment, or any other suitable type of treatment. With heat treatment (e.g., cooking), a temperature of the food product 104 is increased to, or above, a threshold temperature. For example, heat treatment may involve increasing the temperature of the food product 104 to, or above, a threshold temperature and maintaining the food product 104 at the elevated temperature for at least a threshold amount of time. In some examples, individual batches of the food product 104 may be heat-treated within a chamber, such as an oven, a tank, or another type of chamber or vessel. In some examples, the food product 104 may be heat-treated while moving on a transport mechanism (e.g., a conveyor, a screw, a vibrating plate, etc.) through an oven, or the like, as part of a continuous treatment process. With chemical treatment, a chemical may be applied to the food product 104. For example, the food product 104 may be loaded into a chamber and a chemical may be introduced into the chamber at a certain concentration, and the chemical may remain in the chamber with the food product 104 for a period of time in order to reduce the amount of a target pathogen within the food product 104. In some examples, a chemical may be sprayed on the food product 104, or the food product 104 may be submerged in a chemical “bath.”

FIG. 1 also depicts a device 110 located in or near the facility 106. The device 110 is often referred to herein as a “gateway device 110” to denote a device that is used to connect two different networks, such as a programmable logic controller (PLC) network in the facility 106 and the Internet. However, it is to be appreciated that the device 110 is not limited to a gateway device despite numerous references to “gateway device 110” herein. For example, the gateway device 110 may be disposed within the facility 106, or the gateway device 110 may be disposed outside of the facility 106 and within a threshold distance of the facility 106. The gateway device 110 can be implemented as any type and/or any number of computing devices, including a personal computer (PC), a laptop computer, a desktop computer, a mobile phone, tablet computer, a server computer, a router, an access point, or any other electronic device that can transmit data to, and receive data from, other devices, such as over a wired network(s) and/or wireless network(s). Data can also be sent directly by the PLC(s) or a supervisory control and data acquisition (SCADA) system. Accordingly, FIG. 1 depicts the gateway device 110 as being coupled to a network(s) 112, which may represent, or include, any type of public or private network, such as a wide-area network, such as the Internet, data and/or voice networks, a wired infrastructure (e.g., coaxial cable, fiber optic cable, etc.), a wireless infrastructure (e.g., radio frequencies (RF), cellular, satellite, etc.), and/or other connection technologies. In some examples, the gateway device 110 is configured to establish an authenticated (e.g., encrypted) session with the computing system 102 over the network(s) 112. In examples, secure socket layer (SSL) or transport layer security (TLS) protocol is utilized for communication between the gateway device 110 and the computing system 102. In examples, a virtual private network (VPN) is utilized to establish the authenticated session between the gateway device 110 and the computing system 102. It is to be appreciated, however, that any suitable type of network access technology can be utilized.

The gateway device 110 may be connected to equipment 114, such as device, within (e.g., distributed about) the facility 106. Such a connection may be a wired connection or a wireless connection. In some examples, the equipment 114 within the facility 106 may include one or more devices, machines, or the like, such as PLCs. For example, a PLC may be configured to control a temperature inside a tank by causing an element(s) to heat or cool the tank while the tank contains a batch of the food product 104. In some examples, the equipment 114 within the facility 106 may include devices such as sensors. Sensors may include, for example, temperature sensors, pressure sensors, pH sensors, humidity sensors, moisture level sensors, contaminant sensors, and the like. The gateway device 110 may be configured to collect data 118 from any suitable equipment 114 within the facility 106, such as a PLC(s), a sensor(s), and the like. In some examples, the data 118 collected by the gateway device 110 may originate from various pieces of equipment 114 (e.g., devices) distributed about the facility 106, as depicted in FIG. 1 by the first equipment 114(1), second equipment 114(2), third equipment 114(3), and fourth equipment 114(4). In some examples, the equipment 114 represents food processing equipment. In some examples, the equipment 114 is equipment that is not used to process the food product 104, but is used for other purposes (e.g., environmental sampling). In some examples, the equipment 114 may be separate from food processing equipment but associated therewith, such as sensors connected to, or disposed in, food processing equipment. In some examples, the equipment 114 represents one or more computing devices configured to process (e.g., analyze) raw data generated within the facility 106, and to generate, based on the processing of the raw data, processed data 118 and/or resultant data 118 that is ultimately sent, via the gateway device 110, to the computing system 102. In some examples, this “edge computing” capability may be implemented in order to conserve computing resources, such as networking resources, memory resources, or the like. To illustrate, the equipment 114(1) may represent an infrared (IR) camera configured to capture IR images of a raw food product 108 that is to be processed within the facility 106, and the equipment 114(2) may represent a computing device (e.g., image processing device) configured to process the IR images captured by the IR camera to determine results (e.g., “conclusions”) associated with the IR images, such as whether there are deviations within the IR images. In this example, the IR images may be held at the facility 106 (e.g., the IR images may not be sent over the network(s) 112) in order to conserve networking resources (e.g., bandwidth) and/or memory resources of the computing system 102. In this example, the gateway device 110 may exclusively collect the meaningful data 118 (e.g., the results determined by the equipment 114(2) based on processing the IR images) and may send this data 118 over the network(s) 112 to the computing system 102. Because the IR images themselves may be too large to efficiently transfer to the computing system 102, this edge computing implementation may allow for conserving networking resources, among other resources. The image data, in this example, may be maintained in local storage of a computing device(s) (e.g., the equipment 114) within the facility 106 (e.g., to produce evidence, if needed), and/or it may be discarded (e.g., after maintaining the image data for a period of time). It is to be appreciated that image data is merely an example type of data that can be processed by a computing device(s) within the facility 106 and that other types of data can be processed in a similar manner in the above-noted edge computing implementation. In order to collect data 118, the gateway device 110 may interface with the equipment 114 (e.g., by plugging a wire cable into the gateway device 110 and the equipment, by the gateway device 110 establishing a wireless connection with the equipment, etc.). In some examples, the data 118 is collected by the gateway device 110 from the equipment 114 in real-time (e.g., as the equipment 114 generates the data).

The data 118 collected by the gateway device 110 may include contaminant data indicating a level(s) of a contaminant(s) (e.g., a microbial contaminant(s), a chemical contaminant(s), a physical contaminant(s), etc.) detected in the food product 104. For example, the data 118 may include contaminant data generated by a metal detector in the facility 106 that analyzes the food product 104 for the presence (and possibly the level) of metal(s) in the food product 104. Metal is merely an example of a physical contaminant, and other physical contaminants may include, for example, plastics. As mentioned above, contaminants can additionally, or alternatively, include chemical contaminants, such as pesticides, mercury, chemicals found in sanitization products, or the like. In other examples, contaminant data may indicate the level of a pathogen(s), such as Salmonella, in the food product 104. The level of a contaminant represented by contaminant data may be used to determine whether the food product 104 meets a safety standard. As another example, the data 118 collected by the gateway device 110 may include food treatment data, such as temperature data indicative of a temperature of the food product 104 being processed (e.g., a temperature of the food product 104 within a tank used for heat treating the food product 104), pressure data indicative of a pressure of a chamber containing the food product 104, time data indicative of a time (e.g., an amount of time that has lapsed since starting the treatment of the food product 104, a time of day (e.g., a timestamp, such as a time when the data is collected), etc.), chemical concentration data indicative of a concentration of a chemical applied to, or mixed with, the food product 104, pH data indicative of a pH of the food product 104, or any other suitable type of data associated with the treatment of the food product 104, which may be used to determine whether the food product 104 meets a safety standard (e.g., by satisfying a log reduction threshold with respect to a pathogen of interest).

The data 118 collected by the gateway device 110 may include food data indicating a characteristic(s) of the food product 104. For example, machine vision systems may be used to determine the color and/or the texture of the food product 104 from image data of the food product 104. In some examples, odor sensors may be implemented in the facility 106 to detect an odor and/or a smell of the food product 104. In some examples, moisture content, humidity, weight, mass, size/volume, and/or pH of the food product 104 may be detected and included in the food data. Such food data may be used to determine whether the food product meets a quality standard.

The data 118 collected by the gateway device 110 may include packaging data indicating a characteristic(s) of packaging for the food product 104. For example, the packaging data may indicate characteristics such as the material (e.g., plastic, cardboard, paper, foam, metal, etc.) of the package in which the food product 104 is packaged, contained, or wrapped, whether the packaging is air-tight (e.g., hermetically sealed), whether the product is under pressure (e.g., carbonated beverages), a method of packaging (e.g., canned, bottled, boxed, etc.). These packaging characteristics can be used to determine whether the food product 104 meets a packaging standard.

The data 118 collected by the gateway device 110 may include labeling data indicating a characteristic(s) of labeling for the food product 104. For example, the labeling data may indicate characteristics such as the type of label (e.g., a sticker, a tag, a printed label, etc.), whether and what allergens and/or ingredients, nutritional information, etc. is/are listed on the label, a position of the label on the food product 104 and/or on the packaging of the food product 104. These labeling characteristics can be used to determine whether the food product 104 meets a labeling standard. For instance, if a first production run labeled a first food product 104 with allergen information (e.g., “contains nuts”), and the labels were not changed before a second production run for a second food product 104 that contains shellfish (e.g., if the second food product 104 is labeled with incorrect allergen information by failing to indicate that the second food product 104 contains shellfish and/or by incorrectly indicating that the second food product 104 contains nuts), a labeling standard may not be met in this scenario.

The data 118 collected by the gateway device 110 may include environmental data indicating a value(s) of an environmental parameter(s) (e.g., temperature, humidity, ambient light, altitude, air pressure, time of day, etc.) associated with the food processing facility 106 and detected as the different steps 200 of the food production process were carried out to produce the food product 104. For example, at various steps 200 of the food production process, environmental parameters may be detected to determine the environmental conditions in which the food product 104 is processed. These environmental parameter values can be used to determine whether the food product 104 was processed within or under suitable environmental conditions.

The data 118 collected by the gateway device 110 may include storage data indicating a storage condition(s) of the food product 104. For example, at various steps 200 of the food production process, storage conditions of raw food product 108, partially-processed food product, and/or fully-processed food product 104 may be determined including, storage temperature, humidity of the storage environment, duration over which the food product 104 is stored, etc. These storage conditions can be used to determine whether the food product 104 was stored properly.

The data 118 collected by the gateway device 110 may include maintenance data indicating a maintenance action(s) performed on food processing equipment in the food processing facility 106. For example, one or more steps 200 of the food production process may include the performance (e.g., by machines and/or personnel) of maintenance on food processing equipment, such as fixing, calibrating, and/or cleaning (e.g., sanitizing) the equipment in between production runs. Such maintenance data may indicate the chemicals and/or cleaning solutions used to clean the equipment, maintenance activities performed (e.g., methods of cleaning, calibrating, and/or fixing the equipment), and the like, and the maintenance data may be used to determine whether maintenance on the food processing equipment was performed properly.

In some examples, data 118 can be collected from one or more other sources internal and/or external to the facility 106. As an example, FIG. 1 illustrates an external data source(s) 119 that may send data 118 to the computing system 102 over the network(s) 112. In an example, the external data source(s) 119 may represent a third-party laboratory outside of the facility 106 where a food product(s) 104 is tested. Such a laboratory could alternatively be housed within the facility 106. A laboratory may test a food product(s) 104 (e.g., samples of the food product(s) 104) under variable environmental conditions and/or to obtain one or more test results, such as microbial test results (e.g., the presence or absence of a pathogen(s), a level of a pathogen(s), etc.), quality test results (e.g., a presence or absence of an allergen(s), a level of an allergen(s), etc.), or the like. Accordingly, the data 118 received from the external data source 119 may include test result data indicating test results obtained at the laboratory in association with testing a food product 104 (e.g., samples of the food product 104). In some examples, such data 118 may be received from equipment similar to the equipment 114 described above as being used in the facility 106, and/or the data 118 may be received via a gateway device similar to the gateway device 110 described above. In another example, the external data source(s) 119 may represent a supplier and/or a courier of a raw (or unprocessed) food product(s) 108 that is being, or has been, delivered to the facility 106. For example, the data 118 received from the external data source(s) 119 may represent transportation data indicating storage conditions of the raw food product(s) 108 as it is being transported to the facility 106 and/or indicating results of analyses performed by a supplier of the raw food product(s) 108 (e.g., analysis results provided via certificates, such as safety certificates, quality certificates, etc.). In these examples, the data 118 may be received directly from the supplier of the raw food product(s) 108 and/or from the courier delivering the raw food product(s) 108 to the facility 106, such as from computing systems of the supplier and/or computing systems of a delivery vehicle (e.g., sensors and/or transmitters in the back of a delivery truck that provide temperature data, humidity data, etc.).

The gateway device 110 may be configured to reshape the collected data 118, such as by compiling, normalizing, or otherwise reformatting the data 118, and to send the data 118 to the computing system 102 over the network(s) 112. In some examples, the gateway device 110 is configured to generate messages that contain the data 118, and the gateway device 110 may send the messages to the computing system 102 over the network(s) 112. Moreover, the data 118 (e.g., messages containing the data 118) can be sent in real-time as data is collected and processed by the gateway device 110, or the data 118 can be held (e.g., buffered) for a period of time and subsequently sent periodically to the computing system 102. For example, the data 118 can be sent by the gateway device 110 to the computing system 102 in batches of data at regular intervals, or whenever a network connection is available, or whenever bandwidth is above a threshold, or in response to events (e.g., in response to collecting a threshold amount of data from equipment within the facility 106, in response to collecting data pertaining to a particular stage and/or step 200 of the food production process, such as after the final step 200(N), etc.).

In the illustrated implementation, the computing system 102 includes one or more processors 120, and memory 122 (e.g., computer-readable media 122) storing at least a releasability module(s) 124. In some implementations, the processors(s) 120 may include a central processing unit (CPU)(s), a graphics processing unit (GPU)(s), both CPU(s) and GPU(s), a microprocessor, a digital signal processor or other processing units or components known in the art. Alternatively, or in addition, the functionally described herein can be performed, at least in part, by one or more hardware logic components. For example, illustrative types of hardware logic components that can be used include field-programmable gate arrays (FPGAs), application-specific integrated circuits (ASICs), application-specific standard products (ASSPs), system-on-a-chip systems (SOCs), complex programmable logic devices (CPLDs), etc. Additionally, each of the processor(s) 120 may possess its own local memory, which also may store program modules, program data, and/or one or more operating systems.

The memory 122 may include volatile and nonvolatile memory, removable and non-removable media implemented in any method or technology for storage of information, such as computer-readable instructions, data structures, program modules, or other data. Such memory includes, but is not limited to, random access memory (RAM), read-only memory (ROM), electrically erasable programmable read-only memory (EEPROM), flash memory or other memory technology, compact disk (CD)-ROM, digital versatile disks (DVD) or other optical storage, magnetic cassettes, magnetic tape, magnetic disk storage or other magnetic storage devices, redundant array of inexpensive disks (RAID) storage systems, or any other medium which can be used to store the desired information and which can be accessed by a computing device. The memory 122 may be implemented as computer-readable storage media (CRSM), which may be any available physical media accessible by the processor(s) 120 to execute instructions stored on the memory 122. In one basic implementation, CRSM may include RAM and Flash memory. In other implementations, CRSM may include, but is not limited to, ROM, EEPROM, or any other tangible medium which can be used to store the desired information and which can be accessed by the processor(s) 120.

The computing system 102 can be located remotely from the gateway device 110. The computing system 102 may, in some instances, be part of a network-accessible computing platform that is maintained and accessible via a wide area network. Network-accessible computing platforms such as this may be referred to using terms such as “on-demand computing”, “software as a service (Saas)”, “platform computing”, “network-accessible platform”, “cloud services”, “data centers”, and so forth. In this manner, the computing system 102 may be configured to provide particular functionality to large numbers of gateway devices 110 associated with different, geographically-disparate facilities 106.

In general, the computing system 102 may include logic (e.g., software, hardware, and/or firmware, etc.) that is configured to implement the techniques, functionality, and/or operations described herein. The memory 122, for example, can include various modules, such as instructions, datastores, and so forth, which may be configured to execute on the processor(s) 120 for carrying out the techniques, functionality, and/or operations described herein. An example functional module in the form of releasability module(s) 124 is shown in FIG. 1.

The computing system 102 is configured to receive the data 118 (e.g., messages containing the data 118) from the gateway device 110 over the network(s) 112, as shown in FIG. 1. The releasability module(s) 124 is configured to process the data 118 (e.g., messages containing the data 118) received from the gateway device 110. Processing the data 118 (e.g., messages containing the data 118) by the releasability module(s) 124 is described in more detail below with reference to the following figures. In general, the data 118 can be used to determine (e.g., estimate) a releasability metric associated with the food product 104, the releasability metric indicative of a probability of the food product 104 being ready to be released from the facility 106. In some examples, the computing system 102 may store one or more models 126 that are usable to estimate the releasability metric. In some examples, each model 126 may be specific to a food product 104. For example, a first model 126 may be specific to a certain type of meat product, a second model 126 may be specific to a certain type of dairy product, and so on.

In some examples, the model(s) 126 may represent, or include, a mathematical model(s) that define(s) one or more equations including parameters that are usable for determining a releasability metric as described herein. In some examples, the model(s) 126 may represent a rules-based model that define(s) one or more rules for determining a releasability metric based on the data 118. In some examples, the model(s) 126 may represent, a machine learning model(s). Machine learning generally involves processing a set of examples (called “training data”) in order to train a machine learning model(s). A machine learning model(s), once trained, is a learned mechanism that can receive new data as input and estimate or predict a result as output. For example, a trained machine learning model can be a classifier that is tasked with classifying unknown input (e.g., an unknown image) as one of multiple class labels (e.g., labeling the image as a cat or a dog). In some cases, a trained machine learning model is configured to implement a multi-label classification task (e.g., labeling images as “cat,” “dog,” “duck,” “penguin,” and so on). Additionally, or alternatively, a trained machine learning model can be trained to infer a probability, or a set of probabilities, for a classification task based on unknown data received as input. In the context of the present disclosure, the unknown input may include the data 118 associated with different steps 200 of a food production process associated with a food product 104, and the trained machine learning model(s) may be tasked with estimating a releasability metric associated with the food product 104. For example, the trained machine learning model(s) may be configured to output a classification or a score that indicates, or otherwise relates to, a probability of the food product 104 being ready to be released from a food processing facility. In some examples, the trained machine learning model(s) may be configured to output a classification or a score that indicates, or otherwise relates to, a probability of the food product 104 being classified in one of multiple classes indicative of a releasability of the food product 104. For instance, the score output from the trained machine learning model(s) may relate to a probability of the food product 104 being ready for release or not ready for release. The trained machine learning model(s) may represent a single model or an ensemble of base-level machine learning models, and may be implemented as any type of machine learning model. For example, suitable machine learning models for use by the techniques and systems described herein include neural networks (e.g., deep neural networks (DNNs), recurrent neural networks (RNNs), etc.), tree-based models, support vector machines (SVMs), kernel methods, random forests, splines (e.g., multivariate adaptive regression splines), hidden Markov model (HMMs), Kalman filters (or enhanced Kalman filters), Bayesian networks (or Bayesian belief networks), multilayer perceptrons (MLPs), expectation maximization, genetic algorithms, linear regression algorithms, nonlinear regression algorithms, logistic regression-based classification models, or an ensemble thereof. An “ensemble” can include a collection of machine learning models whose outputs (predictions) are combined, such as by using weighted averaging or voting. The individual machine learning models of an ensemble can differ in their expertise, and the ensemble can operate as a committee of individual machine learning models that is collectively “smarter” than any individual machine learning model of the ensemble. Accordingly, a trained machine learning model can be stored by the computing system 102 as a model 126.

Thus, using the data 118, and, in some cases, the model 126, the computing system 102 may repeatedly determine releasability metrics associated with food products 104 that are processed within the facility 106. As releasability metrics are determined by the releasability module(s) 124, the metrics can be stored as food release data 128. In addition, the raw data 118 received from the gateway device 110 may be stored as the food release data 128. In a machine learning example, a model 126 can be trained using a sampled subset of this food release data 128.

In some examples, the releasability metrics determined by the releasability module(s) 124 can be used to classify the food product 104 as one of multiple class labels indicative of a releasability of the food product 104 in terms of whether the food product 104 is ready for release from the facility 106, and these class labels may be stored as the food release data 128. A binary “releasable or not releasable” classification of a food product 104 may be based on whether various criteria are met (e.g., whether thresholds are satisfied). “Satisfying” a threshold, as used herein can mean meeting or exceeding the threshold, or strictly exceeding the threshold. In an example, a safety standard may be met if a level of a contaminant in the food product 104 fails to satisfy a threshold and/or if a reduction metric (e.g., a log reduction value) with respect to a pathogen satisfies a threshold. A “log reduction value,” as used herein, is a value that represents the reduction level of a pathogen, and it is sometimes expressed in terms of the log transformation of the colony forming units (log CFU/g) of the targeted pathogen. As another example, a quality standard may be met if the food product 104 matches a certain color, texture, etc., or if the food product 104 is associated with a certain smell, and/or if a moisture content of the food product 104 satisfies a threshold.

Over time, it can be appreciated that a large amount of food release data 128 can be collected and/or generated as a food product 104 is processed within a facility 106, and this food release data 128 is thereafter accessible to the computing system 102 and to authorized users 130 associated with a food processing entity that operates the facility 106. In some examples, the releasability module(s) 124 is configured to generate reports 132 (e.g., food releasability reports), which may be sent to one or more users 130 automatically and/or at the request of the user 130.

Users 130 may access the food release data 128 and/or receive information 116 associated therewith via user devices 134. For examples, the user devices 134 may be configured to send data to, and receive data from, the computing system 102 over the network(s) 112. The user devices 134 can be implemented as any type and/or any number of computing devices, including a PC, a laptop computer, a desktop computer, a PDA, a mobile phone, tablet computer, a set-top box, a game console, a server computer, a wearable computer (e.g., a smart watch, headset, etc.), or any other electronic device that can transmit data to, and receive data from, other devices. In the example of FIG. 1, a user device(s) 134 is shown as receiving information 116 from the computing system 102. The user(s) 130 who received this information 116 may represent personnel that is authorized to make a decision regarding the release of the food product 104 from the facility 106. Once released, the food product 104 may be distributed to downstream customers and/or consumers. The information 116 may be received and/or displayed by the user device 134 in any suitable digital format, such as an electronic file (e.g., a portable document format (PDF) file), via a web browser, a client application, etc. Users 130 may also be able to print physical (e.g., paper) copies of the information 116. In some examples, the information 116 is displayed in an interactive format (e.g., the users 130 can interact with elements of the information 116 to reveal or hide information, to load curves, generate charts, graphs, to authorize the release of the food product 104, request a hold on the food product 104, redirect the food product 104 to a different end usage, or the like). It is to be appreciated that the information 116 received and displayed at a user device 134 may be unalterable (e.g., a user 130 may be unable to change or manipulate the information 116 so that the information 116 cannot be falsified). In this manner, the information 116 may serve as a reliable source of information (e.g., as evidence) that can be used to demonstrate compliance with standards, rules and/or regulations of customers, providers, and/or a food safety regulating body, such as the FDA in the United States.

FIG. 1 depicts an example user interface 136 that may be displayed on the user device(s) 134. The information 116 displayed via the user interface 136 may represent information 116 that is output (e.g., displayed) based on the releasability metric determined by the releasability module(s) 124. In some examples, the user interface 136 is displayed at the request of a user 130 to view releasability information 116 via the user device(s) 134. In the example of FIG. 1, the information 116 displayed via the user interface 136 may include information about the food product 104, such as an identifier of the food product (e.g., “Food Product: ABC”), as well as information that indicates whether the food product 104 meets various standards, such as a safety standard, a quality standard, a packaging standard, a labeling standard, or the like. For example, a “check mark” next to the relevant standard may indicate that the food product 104 meets the relevant standard. The user 130, in some examples, may select an information element (e.g., encircled “i” icon) to learn more about the food product 104 and/or the events that occurred during processing of the food product 104 within the facility 106 that led to the determination as to whether the relevant standard(s) was/were met. Moreover, as shown in FIG. 1, the information 116 output via the user device 134 indicates whether the food product 104 is ready to be released from the food processing facility 106, such as by displaying a class label indicative of a releasability of the food product 104 (e.g., a Releasable? “Yes” or “No” classification), which is based on the releasability metric indicative of the probability of the food product 104 being ready to be released from the food processing facility 106. The user interface 136 may further include interactive elements 138 and/or 140 that can be interacted with so that the user 130 can indicate a decision as to whether the food product 104 is authorized for release from the facility 106. For example, an “authorize” element 138 (e.g., button) may be selected by the user 130 to authorize the release of the food product 104. In the example of FIG. 1, a “hold” element 140 (e.g., button) may be selected by the user 130 to request that the food product 104 be held from release (e.g., to refrain from releasing the food product 104).

Using the platform 100 described herein, a food processing entity can readily confirm that their food product 104 is ready for release, and an authorized user 130 is able to make an informed decision as to whether to authorize the release of the food product 104 from the facility 106, or to otherwise hold, discard, and/or redirect the food product 104 to a different end usage, such as a different customer. Because data 118 associated with various steps 200 (or stages) of a food production process is gathered automatically (e.g., using equipment 114, such as devices, distributed about the food processing facility 106), and because the data 118 is processed to determine a releasability metric that is easily understandable and that is made readily available to an authorized user 130, the disclosed platform 100 enables the authorized user 130 to make a decision to release the food product 104 in a reduced amount of time, as compared to conventional processes for releasing food products from food processing facilities. That is, the techniques, devices, and systems described herein enable fast release of a food product 104 from a facility 106 where the food product 104 is processed. This time savings, in turn, results in optimizing the processes within a food processing facility 106 to achieve, among other things, higher yield of the food product 104, a reduced time-to-market (e.g., if the food product 104 is released sooner, it can be placed in the market faster and be offered for sale longer), and/or a lower carbon footprint. That is, resources, such as power resources (e.g., energy), processing resources, memory resources, networking resources, and the like, may be conserved by aspects of the techniques and systems described herein. For example, if the disclosed platform 100 determines that a food product 104 is ready to be released, and if food release data 128 associated with the food product 104 indicates that there is room for reducing the consumption of resources within the facility 106 without compromising the releasability of the food product 104 for future production runs, a food processing entity can use the food release data 128 to optimize the food production process (e.g., to process food more efficiently), thereby reducing the environmental impact of processing the food product 104 within the facility 106 through energy conservation and other resource conserving techniques.

The techniques, devices, and systems described herein also allow for determining whether a food product 104 is ready to be released from a facility 106 based on data 118 that is comprehensive and representative of the entire quantity of food product 104, as compared to data that merely represents a random sample (e.g., a small fraction) of the food product that is processed within the facility. For example, by collecting data 118 from various sources and/or equipment 114, such as devices, distributed about the food processing facility 106, and by collecting data 118 that is associated with multiple different steps 200 of a food production process, the data 118 that is collected provides a comprehensive view of the provenance of the food product 104 (e.g., where it came from and what happened to it at each step along the way), which enables an assessment of whether more than just a safety standard is met by the entire food product 104.

The techniques, devices, and systems described herein also provide a reliable system for the retention of food release data 128, at least some of which allows a food processing entity to easily produce the requisite evidence of compliance with various standards, such as safety standards, quality standards, packaging standards, labeling standards, and the like. This evidence is producible on demand for ensuring that customers receive a food product 104 that meets quality standards, and/or for proving, to food safety regulating bodies, such as the FDA in the United States, that a food product 104 is safe and/or that the food product 104 is labeled correctly (e.g., labeled with the correct allergen information).

FIG. 2 illustrates data 118(1) to 118(N) being collected in association with different steps 200(1) to 200(N) of a production process (e.g., a food production process) carried out at a processing facility 106 (e.g., a food processing facility 106) to produce an ingestible product 104 (e.g., a food product 104). As noted above, a food product 104 may be “processed” within a facility 106 in a variety of ways, and the food production process may include a variety of actions performed while a food product 104 is being processed and/or in between production runs of the food product 104. With reference to FIG. 2, a first step 200(1) of the food production process may, for instance, represent storing raw (or unprocessed) food product 108 in a temperature-controlled storage area (e.g., a refrigerator, a freezer, etc.) for a period of time. Accordingly, data 118(1) may represent storage data indicating a storage condition(s) (e.g., temperature(s), humidity(ies), duration, etc.) of the food product 104 while in storage. A second step 200(2) of the food production process may, for instance, represent thawing the raw food product 108, introducing one or more ingredients into the raw food product 108, and heating the mixture to an elevated temperature for a period of time to obtain a cooked food product 104. Accordingly, data 118(2) may represent food data indicating a characteristic(s) of the food product and/or the cooking conditions and/or the recipe for producing a processed food product 104. A third step 200(3) of the food production process may, for instance, represent treating the food product 104 to reduce a target pathogen(s) (e.g., Salmonella) in the food product 104. Accordingly, data 118(3) may represent food treatment data and/or contaminant data relating to the treatment of the food product 104 to reduce the target pathogen(s). A final step 200(N) of the food production process may, for instance, represent cooling a processed and packaged food product 104 in a temperature-controlled storage area (e.g., a refrigerator, a freezer, etc.) before the food product 104 is released. Accordingly, data 118(N) may represent additional storage data indicating a storage condition(s) of the food product 104 while in the final/output storage area and awaiting the distribution of the food product 104 to a customer(s). In some examples, one or more of the steps 200 of the food production process may include packaging the food product 104, labeling the food product 104 (and/or its package), performing maintenance on food processing equipment, such as fixing, calibrating, and/or cleaning (e.g., sanitizing) the equipment in between production runs, or the like. Accordingly, FIG. 2 illustrates that data 118 is collected from various sources throughout a food production process, which helps to provide a comprehensive view of what happened to a food product 104 from start to finish. Moreover, at least some data 118 can be collected from one or more other sources internal and/or external to the facility 106, such as from an external data source(s) 119, as described above with reference to FIG. 1.

FIG. 2 also illustrates that the data 118 may be compiled into a compiled data set 202. This compiling of the data 118 may occur at the computing system 102 where the data 118 is received over the network(s) 112 from the gateway device 110. Compiling the data 118 into the compiled data set 202 may include reshaping the data 118, reformatting the data 118, normalizing the data 118, and/or other data processing operations. FIG. 2 also illustrates that hosted reference data sets 204 may be available to the computing system 102. Such hosted reference data sets 204 may be stored as the food release data 128 introduced in FIG. 1. These hosted reference data sets 204 may be generated as food products 104 are processed within the facility 106, and, therefore, the data sets 204 may represent a history of previously-received data 118 associated with food production processes that have been performed in the past. As mentioned, a machine learning model(s) may be trained on historical data sets collected via the platform 100, such as a sampled set of the hosted reference data sets 204.

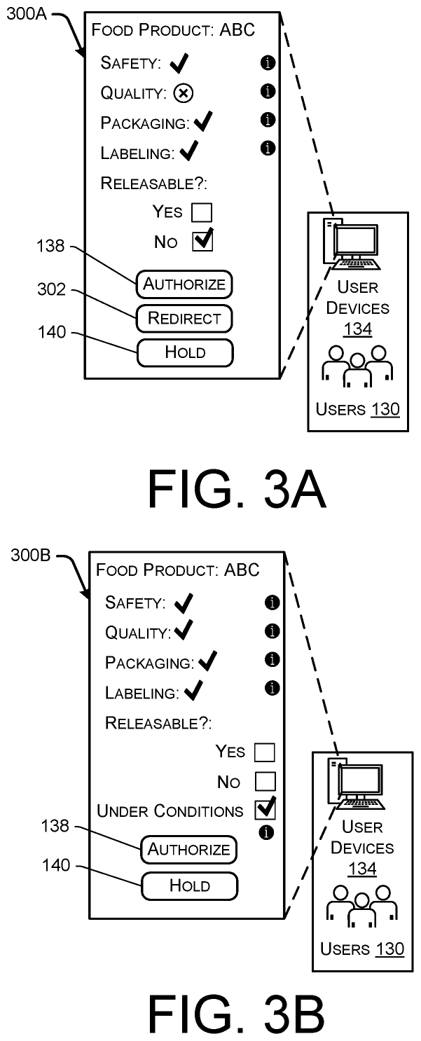

FIG. 3A illustrates an example user interface 300A presenting information that includes a recommendation to redirect 302 an ingestible product 104 (e.g., a food product 104) to a different end usage. In the example of FIG. 3A, the information output via the user device 134 and within the user interface 300A indicates that the food product 104 is not ready to be released from the food processing facility 106 (e.g., a Releasable? “No” classification). As indicated by the “X mark” next to the quality standard in the user interface 300A, the food product 104 may have failed to meet the quality standard. It is to be appreciated that the quality standard is merely an example of a standard that may not be met in a case where the food product 104 is classified as not being ready for release, and that the food product 104 may be classified as not ready for release based on a failure(s) to meet one or more other standards, such as a safety standard, a packaging standard, and/or a labeling standard, etc. In an example where the food product 104 fails to meet a quality standard, the food product 104 produced at the facility 106 may be the wrong color, texture, and/or smell, and/or the food product 104 may have a moisture level that is too low, as exhibited in the food data 118 associated with a step(s) 200 of the food production process for the food product 104. This failure to meet the quality standard—which may be a standard set by the customer for whom the food product 104 is being produced—may result in the releasability metric failing to satisfy a threshold, which indicates that the food product 104 is not, or is unlikely to be, ready for release from the facility 106. In this case, the information output via the user interface 300A displayed on the user device 134 may include a recommendation for salvaging the food product 104 in an effort to minimize food waste. In other words, the food product 104 may not be of high enough quality for a first end usage, such as a first customer, but may still be acceptable for a second end usage different than the first end usage. For instance, the food processing entity may be able to use the food product 104 at its lower quality level for a different end usage, such as by composting the food product and/or otherwise converting the food product into fertilizer for facilitating the growth of a crop. As another example, a second customer, such as a vendor of animal feed products, may still accept the food product 104 at its lower quality level for use in feeding animals. Accordingly, if the food product 104 in the example of FIG. 3A is not of high enough quality for human consumption or if the food product 104 otherwise fails to meet the quality standard set by the first end usage, such as a first customer, it may still be of high enough quality for a second end usage (e.g., animal consumption), and the authorized user 130 may provide user input (e.g., by selecting the “redirect” element 302) to redirect the food product 104 to another customer, which results in salvaging the food product 104, rather than discarding, and, hence, wasting the food product 104.

FIG. 3B illustrates another example user interface 300B presenting information indicating that an ingestible product 104 (e.g., a food product 104) is releasable one or more under conditions. In the example of FIG. 3B, the information output via the user device 134 and within the user interface 300B indicates that the food product 104 is ready to be released from the food processing facility 106 in accordance with one or conditions (e.g., a Releasable? “Under Conditions” classification). For example, different end usages (e.g., different customers) may be associated with different corresponding criteria sets that are to be satisfied before a food product 104 is classified as being ready for release with respect to each end usage (e.g., each customer). To illustrate, a food product 104 may be ready for release to a first customer if a first set of criteria is satisfied, and the food product 104 may be ready for release to a second customer if a second set of criteria is satisfied, the second criteria set being different than the first criteria set, and so on. Accordingly, in the example of FIG. 3B, the food product 104 may meet a first safety standard for a first customer, but the food product 104 may fail to meet a second (e.g., higher) safety standard for a second customer, and, as such, the food product 104 may be ready for release from the facility 106 under the condition that the food product 104 is not released to the second customer. In this example, even though the food product 104 is not ready for release to the second customer, the food product 104 is still ready for release to the first customer. For instance, it may be the case that the first customer and the second customer have different uses for the food product 104 (e.g., they might process the food product 104 differently to make different food products that are ultimately sold to the general public), and these different end usages may be associated with different requirements in terms of regulations pertaining to food safety, for example. In some examples, the user interface 300B includes a selectable information element adjacent to the “Under Conditions” classification. A user 130 can select the information element in order to learn more about the conditions for releasing the food product 104, which may allow the user 130 to make a more informed decision as to whether to authorize 138 to release of the food product 104 or otherwise hold 140, discard, and/or redirect the food product 104 to a different end usage, such as a different customer.

The processes described herein are illustrated as a collection of blocks in a logical flow graph, which represent a sequence of operations that can be implemented in hardware, software, or a combination thereof. In the context of software, the blocks represent computer-executable instructions that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the processes.

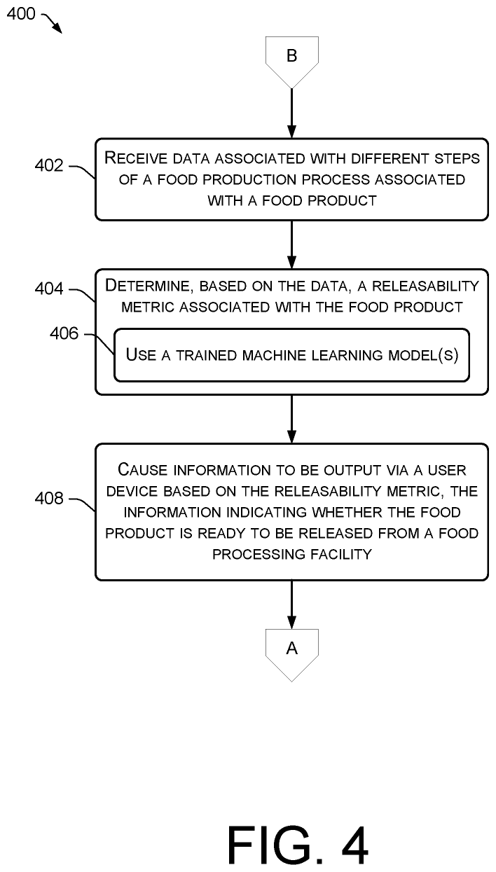

FIG. 4 is a flow diagram of an example process 400 for outputting, via a user device 134, information 116 indicating whether an ingestible produce 104 (e.g., a food product 104) is ready to be released from a processing facility 106 (e.g., a food processing facility 106). The process 400 is described, by way of example, with reference to the previous figures. In some examples, the process 400 may be implemented by the computing system 102 described herein.

At 402, a computing system 102 may receive data 118 associated with different steps 200 of a food production process associated with a food product 104. The data 118 may be received from a gateway device(s) 110 located in or near a facility 106 where the food product 104 is being processed, as described herein. The data 118 may have originated from equipment 114, such as devices, distributed about the food processing facility 106. The equipment 114 that generated the data 118 may be associated with the steps 200 carried out at the facility 106 to produce the food product 104. For example, first data 118(1) received at block 402 may include storage data indicating a storage condition(s) (e.g., a storage temperature) of a raw (or unprocessed) food product 108 delivered to an intake storage room of the facility 106 in association with a first step 200(1) of a food production process. Subsequently, the raw food product 108 may have been moved from the intake storage room to another part of the facility 106 where the raw food product 108 is processed (e.g., cut, ground, and/or pulverized) at a second step 200(2) of the food production process where second data 118(2) is generated. In an example, the second data 118(2) received at block 402 may represent contaminant data indicating a level of a contaminant (e.g., a microbial contaminant(s), a chemical contaminant(s), a physical contaminant(s), etc.) detected in the food product 104 before, during, and/or after the food product 104 is processed at the second step 200(2). In some examples, third data 118(3) received at block 402 may include maintenance data indicating a maintenance action(s) performed on food processing equipment in the facility 106 used to process the food product 104. These are merely examples of the different types of data 118 that can be received at block 402, and other data 118 (e.g., food data, packaging data, labeling data, environmental data, data from an external data source(s) 119, etc.) may be received at block 402. These other types of data are described in more detail elsewhere herein.

At 404, the computing system 102 (e.g., using the releasability module(s) 124) may determine, based at least in part on the data 118 received at block 402, a metric associated with the food product 104, the metric indicative of a probability of the food product 104 being ready to be released from a food processing facility 106. As indicated by block 406, a trained machine learning model(s) 126 may be used to determine this “releasability metric” at block 404. Such a machine learning model(s) 126 may have been trained using a training dataset of historical data (e.g., food release data 128, such as a sampled set of the hosted reference data sets 204 of FIG. 2) associated with the different steps 200 of the food production process. For example, the releasability module(s) 124 may provide the data 118 as input to the model 126 to determine the releasability metric. Other ways of determining the releasability metric at block 404 include using rules, mathematical models, or the like to process the data 118. The releasability metric determined at block 404 may be any suitable indication of the releasability of the food product 104 in terms of its readiness to be released from the facility 106. In some examples, the releasability metric is a class label (e.g., releasable or not releasable), as described herein. In some examples, a confidence level indicator may be determined at block 404, such as a value within a range of 0 to 100% indicative of a confidence level of the determination at block 404. The releasability metric determined at block 404 may be determined at any suitable time, such as after a final step 200(N) of the food production process is completed. In this example, the data 118 used to determine the releasability metric is comprehensive of the food production process because it includes data 118 leading up to the final step 200(N) of the food production process and potentially starting with data 118 collected at or near a first step 200(1) of the food production process, such as a step 200(1) performed at or near a time of delivery of a raw food product 108 to the facility 106.

At 408, the computing system 102 (e.g., the releasability module(s) 124) may cause information 116 to be output via a user device 134 (e.g., by presenting the information 116 in a user interface 136, 300A, 300B) based at least in part on the releasability metric determined at block 404. The information 116 output at block 408 may indicate whether the food product 104 is ready to be released from the food processing facility 106. For example, a binary classification of Releasable? “Yes” or “No,” may be output (e.g., displayed) via the user device 134, as depicted in the user interface 136 of FIG. 1 and the user interface 300A of FIG. 3A, or a classification of Releasable? “Yes,” “No,” or “Under Conditions,” may be output (e.g., displayed) via the user device 134, as depicted in the user interface 300B of FIG. 3B. In some examples, the information 116 output at block 408 may indicate whether the food product 104 meets a safety standard. For example, if a contaminant(s) is not detected in the food product 102, or is detected at a level that fails to satisfy a threshold, the food product 104 may be classified as safe, and, therefore, meets a safety standard that is a prerequisite for release of the food product 104 from the facility 106. As another example, the information 116 output at block 408 may indicate whether the food product 104 meets a quality standard. For example, if a color, texture, smell, and/or moisture content of the food product 104 is per specification (e.g., a specification of the customer for whom the food product 104 is being produced), the food product 104 may be classified as adequate (e.g., high) quality 104, and, therefore, meets a quality standard that is a prerequisite for release of the food product 104 from the facility 106. The information 116 may additionally, or alternatively, indicate whether the food product 104 meets a packaging standard, a labeling standard, or the like, and/or whether the food product 104 was stored properly, processed within or under environmental conditions that are deemed suitable for processing the food product 104, and/or whether maintenance on food processing equipment used to process the food product 104 was performed properly.

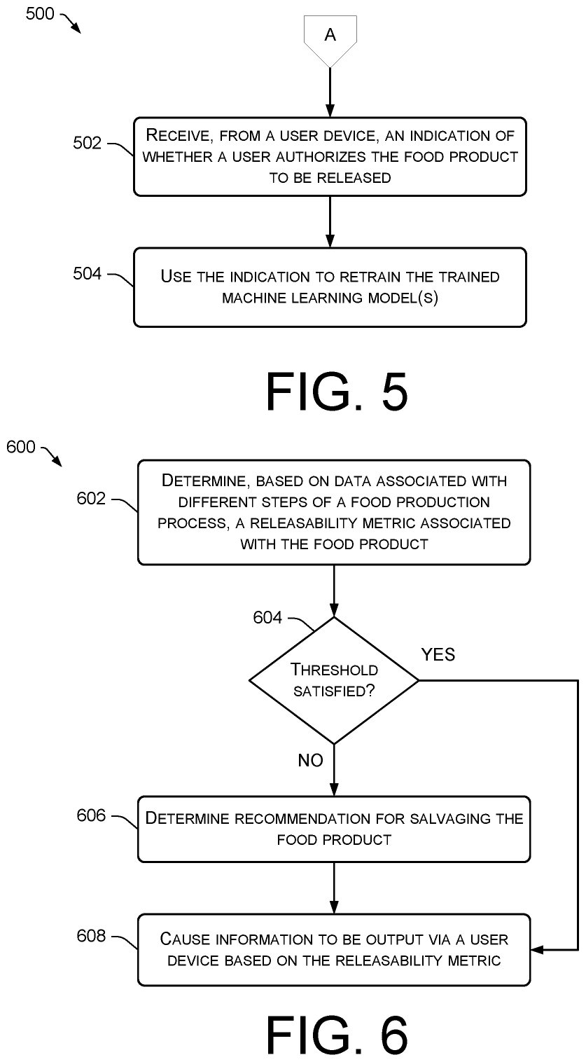

FIG. 5 illustrates a flow diagram of an example process 500 for retraining a trained machine learning model(s) 126 based on feedback received from a user 130 who is authorized to release ingestible products 104 (e.g., food products 104) from a processing facility 106 (e.g., a food processing facility 106). The process 500 is described, by way of example, with reference to the previous figures. In some examples, the process 500 may be implemented by the computing system 102 described herein. As shown by the off-page reference “A” in FIGS. 4 and 5, the process 500 may continue from block 408 of the process 400.

At 502, a computing system 102 may receive, from the user device 134, an indication of whether a user 130 of the user device 134 authorizes a food product 104 to be released from the food processing facility 106. The indication may be received at block 502 based on user input provided to the user device 134, such as voice-based input or touch-based input (e.g., user input received by the user device 134 via a touch screen), a gesture made by the user 130, or the like. In the examples of FIG. 1 and FIG. 3B, the user 130 may provide input by selecting the “authorize” element 138 (e.g., button) via the user interface 136, or by selecting the “hold” element 140 (e.g., button) via the user interface 136. Selection of the “authorize” element 138 indicates that the user 130 authorizes the food product 104 to be released from the facility 106, and selection of the “hold” element 140 indicates that the user 130 does not authorize the food product 104 to be released from the facility 106. In the latter case, the user 130 may request that the food product 104 be held at the facility 106, at least temporarily. In the example of FIG. 3B, if the food product 104 is classified as releasable “Under Conditions,” selection of the “authorize” element 138 indicates that the user 130 authorizes the food product 104 to be released in accordance with the one or more conditions (e.g., to a first customer but not to a second customer). In the example of FIG. 3A, the user 130 may provide input by selecting the “redirect” element 302 (e.g., button) via the user interface 300A. Selection of the “redirect” element 302 indicates that, while the user 130 does not authorize the food product 104 for release to a first customer, the user 130 authorizes the release of the food product 104 to a second customer. An indication may be received at block 502 based on any of these example user inputs, and/or based on other types of user inputs.

At 504, the computing system 102 may use the indication received at block 502 to retrain a trained machine learning model(s) 126. For example, the trained machine learning model(s) 126 may have been used to determine the releasability metric for the food product 104 at block 404 of the process 400 (as indicated by sub-block 406). In one example, the releasability metric determined at block 404 indicates that the food product 104 is, or is likely to, be ready to be released from the facility 106 (e.g., by the releasability metric satisfying a threshold), and the indication received at block 502 is that the user 130 does not authorize the release of the food product 104. In this example, there is disagreement, or discordance, between the output of the trained machine learning model(s) 126 and the decision made by the user 130. Accordingly, the food release data 128 associated with the production run of the food product 104 where the user 130 decided not to release the food product 104 may be added to a training dataset for the trained machine learning model(s) 126, and the added training data may be labeled with the indication received at block 502 as an example of a food product 104 that was not released from the facility 106. In this manner, the model(s) 126 can be retrained at block 504 with the new training data. Over time, the model(s) 126 gets “smarter” by learning from the input of authorized users 130 who decide whether or not to release the food product 104 from the facility 106. In another example, there may be agreement, or concordance, between the output of the trained machine learning model(s) 126 and the decision made by the user 130 (e.g., the user 130 may select the “authorize” element 138 in the example of FIG. 1 after the model(s) 126 outputs a releasability metric that indicates that the food product 104 is, or is likely to, be ready to be released from the facility 106). Accordingly, the indication of such user input may be received at block 502 and used to reinforce the model's training.

FIG. 6 is a flow diagram of an example process 600 for outputting, via a user device 134, information that includes a recommendation for salvaging an ingestible product 104 (e.g., a food product 104) if a releasability metric associated with the ingestible product 104 fails to satisfy a threshold. The process 600 is described, by way of example, with reference to the previous figures. In some examples, the process 600 may be implemented by the computing system 102 described herein.

At 602, a computing system 102 may determine, based at least in part on data 118 associated with different steps 200 of a food production process associated with a food product 104, a releasability metric associated with the food product 104. The releasability metric determined at block 602 is indicative of a probability of the food product 104 being ready to be released from a food processing facility 106. Accordingly, the operation(s) performed at block 602 may be similar to those performed at blocks 402-406 of the process 400 described above with reference to FIG. 4.

At 604, the computing system 102 may determine whether the releasability metric satisfies a threshold (e.g., a threshold of 0.8 on a scale from 0 to 1). If the releasability metric fails to satisfy the threshold, indicating that the food product 104 is not, or is unlikely to be, ready for release from the food processing facility 106, the process 600 may follow the NO route from block 604 to block 606.

At 606, the computing system 102 may determine a recommendation for salvaging the food product 104. For example, depending on what caused the failure of the releasability metric to satisfy the threshold, the food product 104 may be salvageable. For instance, if a reduction of a pathogen (e.g., Salmonella) does not satisfy a threshold level of reduction, the food product 104 may be treated further to reduce the pathogen (e.g., by treating the food product 104 with a second round of heat treatment, chemical treatment, or the like, to “kill” the pathogen) and salvage the food product 104 for a first customer or for a different end usage, such as a different customer. In some examples, the quality of the food product 104 does not meet a quality standard, which may have led to the releasability metric failing to satisfy the threshold. In this example, a different customer may accept the food product 104 at the lower quality level. Accordingly, in some examples, the recommendation determined at block 606 may be a recommendation to redirect the food product 104 to a second customer different than the first customer, such as a farm or another vendor who can use the food product 104 for animal feed or for some other purpose.

At 608, the computing system 102 may cause information 116 to be output via a user device 134 based at least in part on the releasability metric determined at block 602. For example, based on the releasability metric failing to satisfy the threshold at block 604, and following block 606, the information 116 output at block 608 may include a recommendation for salvaging the food product 104. An example of such a recommendation is shown in the example user interface 300A of FIG. 3A where the user 130 can redirect the food product 104 to a different end usage, such as a different customer, by selecting the “redirect” element 302 (e.g., a recommendation to redirect the food product 104). Another example of such a recommendation is shown in the example user interface 300B of FIG. 3B where the food product 104 is classified as releasable under one or more conditions, and the user 130 can select the “authorize” element 138 to release the food product 104 in accordance with the one or more conditions (e.g., to a particular customer who does not require the releasability metric to satisfy the threshold). If, at block 604, the releasability metric satisfies the threshold, the process 600 may follow the YES route from block 604 to block 608 without determining a recommendation for salvaging the food product 104 at block 606. In this example, the information 116 output at block 608 may not include a recommendation for salvaging the food product 104, and may otherwise indicate that the food product 104 is, or is likely to be, ready to be released from the food processing facility 106, as described herein. Thus, the process 600 may be implemented to dynamically determine whether to recommend salvaging a food product 104 whose releasability metric fails to satisfy a threshold. In this manner, food waste can be reduced or mitigated by salvaging the food product 104.

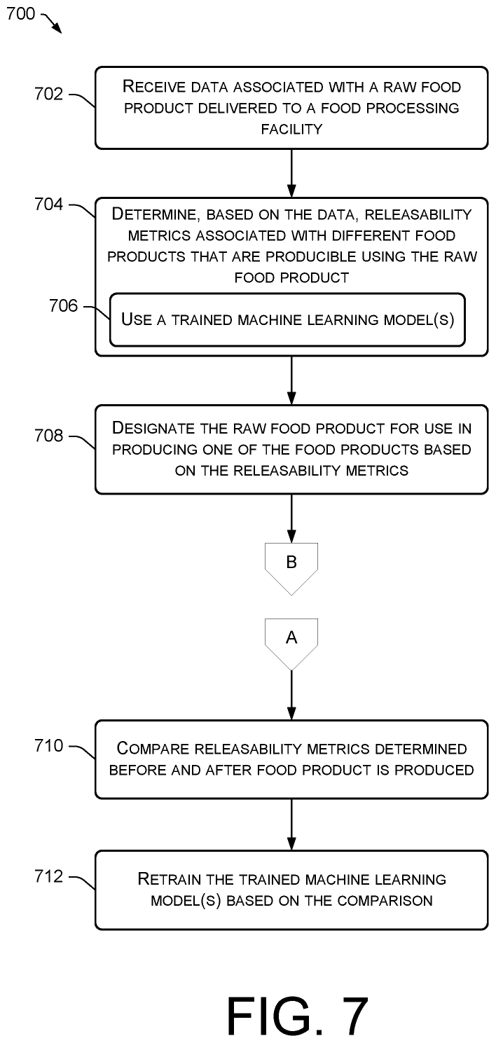

FIG. 7 is a flow diagram of an example process 700 for triaging a raw (or unprocessed) ingestible product 108 (e.g., a raw food product 108) based on releasability metrics determined before the raw ingestible product 108 is used to produce an ingestible product 104 (e.g., a food product 104), and for retraining a trained machine learning model(s) 126 based on releasability metrics determined before and after the ingestible product 104 is produced. The process 700 is described, by way of example, with reference to the previous figures. In some examples, the process 700 may be implemented by the computing system 102 described herein.

At 702, a computing system 102 may receive first data 118 associated with a raw food product 108 delivered to a food processing facility 106. With reference to FIG. 2, the first data 118 received at block 702 may be received prior to or during the first step 200(1) of the food production process. For example, the first data 118(1) received at block 702 may include any suitable data regarding the raw (or unprocessed) food product 108, such as food data indicating a characteristic(s) (e.g., weight, color, texture, smell, moisture level, etc.) of the raw food product 108, contaminant data indicating a level of a contaminant(s) detected in the raw food product 108, storage data indicating a storage condition(s) (e.g., a storage temperature, humidity, duration, etc.) of the raw food product 108 after delivery of the raw food product 108 to a temperature-controlled intake storage room of the facility 106, or the like. The raw food product 108 may be usable for producing multiple different food products 104. For example, if the raw food product 108 is chicken, the unprocessed chicken may be processed within the facility 106 to produce chicken pot pies, chicken casseroles, chicken nuggets, pet food with chicken as an ingredient, or any other suitable type of food product 104. Accordingly, the first data 118 received at block 702 may be informative as to which food product 104 is best suited for the particular shipment of raw food product 108.

At 704, the computing system 102 may determine, based at least in part on the first data 118 received at block 702, and prior to or during a first step 200(1) of a food production process (e.g., storage of the raw food product 108), first releasability metrics associated with the different food products 104 that are producible using the raw food product 108, wherein the first releasability metrics are indicative of respective probabilities of the different food products 104 being ready to be released from the food processing facility 106. The first releasability metrics may be determined at block 704 for individual food products 104 using the techniques described herein, such as by performing the operation(s) of block 404 of the process 400 described above with reference to FIG. 4. In the running example, a first of the first releasability metrics may be determined for chicken pot pies based on the first data 118(1) received at block 702, a second of the first releasability metrics may be determined for chicken casseroles based on the first data 118(1) received at block 702, a third of the first releasability metrics may be determined for chicken nuggets based on the first data 118(1) received at block 702, a fourth of the first releasability metrics may be determined for pet food with chicken as an ingredient based on the first data 118(1) received at block 702, and so on and so forth for any suitable number of different food products 104 that are producible using the raw food product 108. As indicated by block 706, a trained machine learning model(s) 126 may be used to determine the multiple first releasability metrics at block 706. The operation(s) performed at block 706 may be similar to those performed at block 406 and described above with reference to FIG. 4. In some examples, multiple different trained machine learning models 126 may be used at block 706, each model 126 specific to one of the food products 104 for which a releasability metric is determined. For example, a first model 126 may be specific to a chicken pot pies, a second model 126 may be specific to chicken casseroles, and so on. It is to be appreciated that the first releasability metrics determined at block 704 may vary due to the different food products 104, and potentially due to the use of different product-specific models 126 at block 706.

At 708, the computing system 102 may designate the raw food product 108 for use in producing one of the multiple food products 104 based at least in part on the first releasability metrics determined at block 704. For example, the first releasability metrics determined at block 704 may be ranked (or sorted) from highest to lowest, and the raw food product 108 may be designated for use in producing the food product 104 associated with the highest releasability metric of the first releasability metrics. This may maximize the chance of the food product 104 being released from the facility 106. In some examples, other factors may be considered in determining which food product 104 the raw food product 108 should be designated for. Such other factors may include economic factors, such as supply and demand, profitability, or the like, and/or environmental impact, such as respective amounts of energy consumption used to produce each food product 104, or the like. For instance, if the raw food product 108 is determined to have a relatively high level of a contaminant and will therefore have to undergo treatment within the facility 106 to reduce the level of the contaminant to render the food product 104 safe for consumption, the food product 104 for which the raw food product 108 is designated may be chosen as the food product 104 that will result in the lowest amount of energy consumed to treat the food product 104 for purposes of contaminant reduction, thereby conserving resources (e.g., energy resources).

As indicated by the off-page reference “B” in FIGS. 4 and 7, the process 400 may continue from block 708 of the process 700 with respect to the selected/designated food product 104. For example, if the raw food product 108 is designated for chicken casseroles at block 708 (e.g., due to the releasability metric associated with chicken casseroles being the highest among the first releasability metrics determined at block 704), the process 400 may be performed with respect to the chicken casserole food product 104. In other words, the second data 118 received at block 402 may be associated with different steps 200 of a food production process associated with chicken casseroles.

As indicated by the off-page reference “A” in FIGS. 4 and 7, the process 700 may resume at block 710 following block 408 of the process 400. That is, the process 400 may be performed based on the processing of the raw food product 108 within the facility 106 to produce the food product 104 (e.g., chicken casseroles), and a second releasability metric may have been determined in association with the food product 104 at block 404 of the process 400 (e.g., by using a trained machine learning model(s) 126 at block 406).

At 710, the computing system 102 may compare the second releasability metric determined at block 404 in association with the food product 104 (e.g., chicken casseroles) with the first releasability metric determined at block 704 in association with the food product 104 (e.g., chicken casseroles) at a time prior to or during a first step 200(1) of the food production process. In other words, the comparison at block 710 may compare two different releasability metrics determined for the same food product 104, but at different times. For instance, the first releasability metric can be determined proximate to the delivery of the raw food product 108 (e.g., chicken) to the facility 106, and the second releasability metric can be determined at a time after the food product 104 (e.g., chicken casserole) was produced using the raw food product 108 (e.g., after the final step 200(N) of the food production process). The two releasability metrics could be the same, or they could be different. Furthermore, the two releasability metrics may be computed using the same trained machine learning model(s) 126 or using different model(s) 126.

At 712, the computing system 102 may retrain the trained machine learning model(s) 126 used to determine the two releasability metrics based at least in part on the comparing at block 710. In some examples, human input may be utilized as part of the retraining performed at block 712. For example, if an authorized user 130 happened to authorize the release of the food product 104 (e.g., chicken casserole), as described herein, and if the second releasability metric is greater than the first releasability metric, the retraining performed at block 712 may be geared towards improving the performance of the model(s) 126 at the intake stage when the raw food product 108 is delivered to the facility 106. This may be accomplished by adding the first data 118 received at block 702 to a training dataset and labeling the first data 118 with a “releasable” label to indicate that the first data 118 is associated with a food product 104 that was ultimately authorized for release from the facility 106 by an authorized user 130. In this way, the model(s) 126 may adapt and improve over time to get better at predicting earlier in a food production pipeline whether a food product 104 will be ready to be released from a facility 106 once the food product 104 is produced.

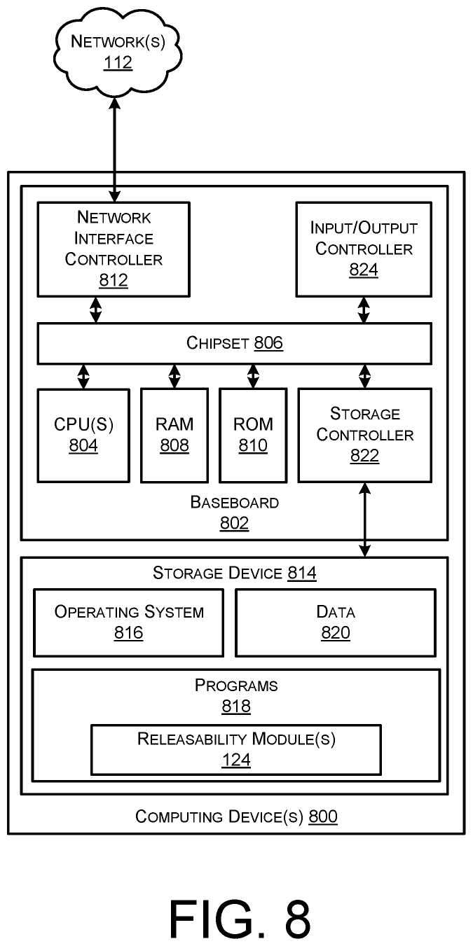

FIG. 8 shows an example computer architecture for a computing device(s) 800 capable of executing program components for implementing the functionality described above. The computer architecture shown in FIG. 8 may represent a workstation, desktop computer, laptop, tablet, network appliance, smartphone, server computer, or other computing device, and can be utilized to execute any of the software components presented herein. For example, the computing device(s) 800 may represent a server(s) of the computing system 102. As another example, the computing device(s) 800 may represent the gateway device 110.

The computer 800 includes a baseboard 802, which is a printed circuit board (PCB) to which a multitude of components or devices can be connected by way of a system bus or other electrical communication paths. In one illustrative configuration, one or more CPUs 804 operate in conjunction with a chipset 806. The CPUs 804 can be standard programmable processors that perform arithmetic and logical operations necessary for the operation of the computer 800, and the CPUs 804 may be the same as, or similar to, the processor(s) 120 of FIG. 1.

The CPUs 804 perform operations by transitioning from one discrete, physical state to the next through the manipulation of switching elements that differentiate between and change these states. Switching elements can generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 806 provides an interface between the CPUs 804 and the remainder of the components and devices on the baseboard 802. The chipset 806 may represent the “hardware bus” described above, and it can provide an interface to a RAM 808, used as the main memory in the computing device(s) 800. The chipset 806 can further provide an interface to a computer-readable storage medium such as a read-only memory (“ROM”) 810 or non-volatile RAM (“NVRAM”) for storing basic routines that help to startup the computer 800 and to transfer information between the various components and devices. The ROM 810 or NVRAM can also store other software components necessary for the operation of the computing device(s) 800 in accordance with the configurations described herein.

The computing device(s) 800 can operate in a networked environment using logical connections to remote computing devices and computer systems through a network, such as the network 112 of FIG. 1. The chipset 806 can include functionality for providing network connectivity through a network interface controller (NIC) 812, such as a gigabit Ethernet adapter. The NIC 812 may be capable of connecting the computing device(s) 800 to other computing devices over the network 712. It should be appreciated that multiple NICs 812 can be present in the computing device(s) 800, connecting the computer to other types of networks and remote computer systems.

The computing device(s) 800 can be connected to a mass storage device 814 that provides non-volatile storage for the computer. The mass storage device 816 can store an operating system 816, programs 818, and data 820, to carry out the techniques and operations described in greater detail herein. For example, the programs 818 may include the releasability module(s) 124 described herein, and the data 820 may include the model(s) 126, the food release data 128, and/or the reports 132 described elsewhere herein. The mass storage device 814 can be connected to the computing device 800 through a storage controller 822 connected to the chipset 806. The mass storage device 814 can consist of one or more physical storage units. The storage controller 822 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computing device(s) 800 can store data on the mass storage device 814 by transforming the physical state of the physical storage units to reflect the information being stored. The specific transformation of physical state can depend on various factors, in different implementations of this description. Examples of such factors can include, but are not limited to, the technology used to implement the physical storage units, whether the mass storage device 814 is characterized as primary or secondary storage, and the like.

For example, the computing device(s) 800 can store information to the mass storage device 814 by issuing instructions through the storage controller 822 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device(s) 800 can further read information from the mass storage device 814 by detecting the physical states or characteristics of one or more particular locations within the physical storage units.

In addition to the mass storage device 814 described above, the computing device(s) 800 can have access to other computer-readable storage media to store and retrieve information, such as program modules, data structures, or other data. It should be appreciated by those skilled in the art that computer-readable storage media is any available media that provides for the non-transitory storage of data and that can be accessed by the computing device(s) 800.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

In one configuration, the mass storage device 814 or other computer-readable storage media is encoded with computer-executable instructions which, when loaded into the computing device(s) 800, transform the computer from a general-purpose computing system into a special-purpose computer capable of implementing the configurations described herein. These computer-executable instructions transform the computing device(s) 800 by specifying how the CPUs 804 transition between states, as described above. According to one configuration, the computing device(s) 800 has access to computer-readable storage media storing computer-executable instructions which, when executed by the computing device(s) 800, perform the various processes described above. The computing device(s) 800 can also include computer-readable storage media storing executable instructions for performing any of the other computer-implemented operations described herein. Any of the computer-readable storage media depicted in FIG. 8 may be the same as, or similar to, the memory 122 of FIG. 1.

The computing device(s) 800 can also include one or more input/output controllers 824 for receiving and processing input from a number of input devices, such as a keyboard, a mouse, a touchpad, a touch screen, an electronic stylus, or other type of input device. Similarly, an input/output controller 824 can provide output to a display, such as a computer monitor, a flat-panel display, a digital projector, a printer, or other type of output device.

### EXAMPLE CLAUSES

1. A method for determining whether a food product is ready to be released from a food processing facility where the food product is processed, the method comprising: receiving data associated with different steps of a food production process carried out at the food processing facility to produce the food product; determining, based at least in part on the data, a releasability metric associated with the food product, the releasability metric indicative of a probability of the food product being ready to be released from the food processing facility; and causing information to be output via a user device based at least in part on the releasability metric, wherein the information indicates whether the food product is ready to be released from the food processing facility.
2. The method of clause 1, wherein the information further indicates one or more of: whether the food product meets a safety standard; whether the food product meets a quality standard; whether the food product meets a packaging standard; or whether the food product meets a labeling standard.
3. The method of clause 1 or 2, wherein the data comprises one or more of: contaminant data indicating levels of contaminants detected in the food product, wherein the levels of contaminants are used to determine whether the food product meets a safety standard; food data indicating characteristics of the food product, wherein the characteristics of the food product are used to determine whether the food product meets a quality standard; packaging data indicating characteristics of packaging for the food product, wherein the characteristics of the packaging are used to determine whether the food product meets a packaging standard; labeling data indicating characteristics of labeling for the food product, wherein the characteristics of the labeling are used to determine whether the food product meets a labeling standard; environmental data indicating values of environmental parameters associated with the food processing facility that were detected as the different steps of the food production process were carried out to produce the food product; storage data indicating storage conditions of the food product; or maintenance data indicating maintenance actions performed on food processing equipment in the food processing facility.
4. The method of any one of clauses 1 to 3, wherein the data originated from devices distributed about the food processing facility.
5. A system comprising: one or more processors; and memory storing computer-executable instructions that, when executed by the one or more processors, cause performance of operations comprising: receiving data associated with different steps of a food production process associated with a food product; determining, based at least in part on the data, a metric associated with the food product, the metric indicative of a probability of the food product being ready to be released from a food processing facility; and causing information to be output via a user device based at least in part on the metric, wherein the information indicates whether the food product is ready to be released from the food processing facility.
6. The system of clause 5, wherein the information further indicates one or more of: whether the food product meets a safety standard; whether the food product meets a quality standard; whether the food product meets a packaging standard; or whether the food product meets a labeling standard.
7. The system of clause 5 or 6, wherein the metric is determined using a trained machine learning model that was trained using a training dataset of historical data associated with the different steps of the food production process.
8. The system of clause 7, the operations further comprising: receiving, from the user device, an indication of whether a user of the user device authorizes the food product to be released from the food processing facility; and using the indication to retrain the trained machine learning model.
9. The system of any one of clauses 5 to 8, the operations further comprising: determining that the metric fails to satisfy a threshold indicating that the food product is unlikely to be ready for release from the food processing facility, wherein the information includes a recommendation for salvaging the food product.
10. The system of clause 9, wherein: the food production process was carried out to produce the food product for a first end usage; and the recommendation for salvaging the food product comprises a recommendation to redirect the food product to a second end usage different than the first end usage.
11. The system of any one of clauses 5 to 10, wherein the data comprises one or more of: contaminant data indicating a level of a contaminant detected in the food product, wherein the level of contaminant is usable to determine whether the food product meets a safety standard; food data indicating a characteristic of the food product, wherein the characteristic of the food product is usable to determine whether the food product meets a quality standard; packaging data indicating a characteristic of packaging for the food product, wherein the characteristic of the packaging is usable to determine whether the food product meets a packaging standard; labeling data indicating a characteristic of labeling for the food product, wherein the characteristic of the labeling is usable to determine whether the food product meets a labeling standard; environmental data indicating a value of an environmental parameter associated with the food processing facility that was detected as the different steps of the food production process were carried out to produce the food product; storage data indicating a storage condition of the food product; or maintenance data indicating a maintenance action performed on food processing equipment in the food processing facility.
12. The system of any one of clauses 5 to 11, wherein the data originated from equipment distributed about the food processing facility.
13. The system of any one of clauses 5 to 12, wherein the metric is determined after a final step of the food production process is completed.
14. The system of clause 13, wherein the data is second data, and the metric is a second metric, the operations further comprising: receiving first data associated with a raw food product delivered to the food processing facility, wherein the raw food product is usable for producing different food products including the food product; determining, based at least in part on the first data, and prior to or during a first step of the food production process, first metrics associated with the different food products that are producible using the raw food product, wherein the first metrics are indicative of respective probabilities of the different food products being ready to be released from the food processing facility; and designating the raw food product for use in producing the food product based at least in part on the first metrics.
15. The system of clause 14, wherein the first metrics and the second metric are determined using a trained machine learning model, the operations further comprising: comparing the second metric with one of the first metrics that is associated with the food product; and retraining the trained machine learning model based at least in part on the comparing.
16. A method comprising: receiving data associated with different steps of a food production process associated with a food product; determining, based at least in part on the data, a metric associated with the food product, the metric indicative of a probability of the food product being ready to be released from a food processing facility; and causing information to be output via a user device based at least in part on the metric, wherein the information indicates whether the food product is ready to be released from the food processing facility.
17. The method of clause 16, wherein the information further indicates one or more of: whether the food product meets a safety standard; whether the food product meets a quality standard; whether the food product meets a packaging standard; or whether the food product meets a labeling standard.
18. The method of clause 16 or 17, wherein the metric is determined using a trained machine learning model that was trained using a training dataset of historical data associated with the different steps of the food production process.
19. The method of any one of clauses 16 to 18, wherein the data comprises one or more of: contaminant data indicating a level of a contaminant detected in the food product, wherein the level of contaminant is usable to determine whether the food product meets a safety standard; food data indicating a characteristic of the food product, wherein the characteristic of the food product is usable to determine whether the food product meets a quality standard; packaging data indicating a characteristic of packaging for the food product, wherein the characteristic of the packaging is usable to determine whether the food product meets a packaging standard; labeling data indicating a characteristic of labeling for the food product, wherein the characteristic of the labeling is usable to determine whether the food product meets a labeling standard; environmental data indicating a value of an environmental parameter associated with the food processing facility that was detected as the different steps of the food production process were carried out to produce the food product; storage data indicating a storage condition of the food product; or maintenance data indicating a maintenance action performed on food processing equipment in the food processing facility.
20. The method of any one of clauses 16 to 19, wherein the metric is determined after a final step of the food production process is completed.
21. A method for determining whether an ingestible product is ready to be released from a facility where the ingestible product is processed, the method comprising: receiving data associated with different steps of a production process carried out at the facility to produce the ingestible product; determining, based at least in part on the data, a releasability metric associated with the ingestible product, the releasability metric indicative of a probability of the ingestible product being ready to be released from the facility; and causing information to be output via a user device based at least in part on the releasability metric, wherein the information indicates whether the ingestible product is ready to be released from the facility.
22. The method of clause 21, wherein the information further indicates one or more of: whether the ingestible product meets a safety standard; whether the ingestible product meets a quality standard; whether the ingestible product meets a packaging standard; or whether the ingestible product meets a labeling standard.
23. The method of clause 21 or 22, wherein the data comprises one or more of: contaminant data indicating levels of contaminants detected in the ingestible product, wherein the levels of contaminants are used to determine whether the ingestible product meets a safety standard; data indicating characteristics of the ingestible product, wherein the characteristics of the ingestible product are used to determine whether the ingestible product meets a quality standard; packaging data indicating characteristics of packaging for the ingestible product, wherein the characteristics of the packaging are used to determine whether the ingestible product meets a packaging standard; labeling data indicating characteristics of labeling for the ingestible product, wherein the characteristics of the labeling are used to determine whether the ingestible product meets a labeling standard; environmental data indicating values of environmental parameters associated with the facility that were detected as the different steps of the production process were carried out to produce the ingestible product; storage data indicating storage conditions of the ingestible product; or maintenance data indicating maintenance actions performed on processing equipment in the facility.
24. The method of any one of clauses 21 to 23, wherein the data originated from devices distributed about the facility.
25. A system comprising: one or more processors; and memory storing computer-executable instructions that, when executed by the one or more processors, cause performance of operations comprising: receiving data associated with different steps of a production process associated with an ingestible product; determining, based at least in part on the data, a metric associated with the ingestible product, the metric indicative of a probability of the ingestible product being ready to be released from a facility; and causing information to be output via a user device based at least in part on the metric, wherein the information indicates whether the ingestible product is ready to be released from the facility.
26. The system of clause 25, wherein the information further indicates one or more of: whether the ingestible product meets a safety standard; whether the ingestible product meets a quality standard; whether the ingestible product meets a packaging standard; or whether the ingestible product meets a labeling standard.
27. The system of clause 25 or 26, wherein the metric is determined using a trained machine learning model that was trained using a training dataset of historical data associated with the different steps of the production process.
28. The system of clause 27, the operations further comprising: receiving, from the user device, an indication of whether a user of the user device authorizes the ingestible product to be released from the facility; and using the indication to retrain the trained machine learning model.
29. The system of any one of clauses 25 to 28, the operations further comprising: determining that the metric fails to satisfy a threshold indicating that the ingestible product is unlikely to be ready for release from the facility, wherein the information includes a recommendation for salvaging the ingestible product.
30. The system of clause 29, wherein: the production process was carried out to produce the ingestible product for a first end usage; and the recommendation for salvaging the ingestible product comprises a recommendation to redirect the ingestible product to a second end usage different than the first end usage.
31. The system of any one of clauses 25 to 30, wherein the data comprises one or more of: contaminant data indicating a level of a contaminant detected in the ingestible product, wherein the level of contaminant is usable to determine whether the ingestible product meets a safety standard; data indicating a characteristic of the ingestible product, wherein the characteristic of the ingestible product is usable to determine whether the ingestible product meets a quality standard; packaging data indicating a characteristic of packaging for the ingestible product, wherein the characteristic of the packaging is usable to determine whether the ingestible product meets a packaging standard; labeling data indicating a characteristic of labeling for the ingestible product, wherein the characteristic of the labeling is usable to determine whether the ingestible product meets a labeling standard; environmental data indicating a value of an environmental parameter associated with the facility that was detected as the different steps of the production process were carried out to produce the ingestible product; storage data indicating a storage condition of the ingestible product; or maintenance data indicating a maintenance action performed on processing equipment in the facility.
32. The system of any one of clauses 25 to 31, wherein the data originated from equipment distributed about the facility.
33. The system of any one of clauses 25 to 32, wherein the metric is determined after a final step of the production process is completed.
34. The system of clause 33, wherein the data is second data, and the metric is a second metric, the operations further comprising: receiving first data associated with a raw ingestible product delivered to the facility, wherein the raw ingestible product is usable for producing different ingestible products including the ingestible product; determining, based at least in part on the first data, and prior to or during a first step of the production process, first metrics associated with the different ingestible products that are producible using the raw ingestible product, wherein the first metrics are indicative of respective probabilities of the different ingestible products being ready to be released from the facility; and designating the raw ingestible product for use in producing the ingestible product based at least in part on the first metrics.
35. The system of clause 34, wherein the first metrics and the second metric are determined using a trained machine learning model, the operations further comprising: comparing the second metric with one of the first metrics that is associated with the ingestible product; and retraining the trained machine learning model based at least in part on the comparing.
36. A method comprising: receiving data associated with different steps of a production process associated with an ingestible product; determining, based at least in part on the data, a metric associated with the ingestible product, the metric indicative of a probability of the ingestible product being ready to be released from a facility; and causing information to be output via a user device based at least in part on the metric, wherein the information indicates whether the ingestible product is ready to be released from the facility.
37. The method of clause 36, wherein the information further indicates one or more of: whether the ingestible product meets a safety standard; whether the ingestible product meets a quality standard; whether the ingestible product meets a packaging standard; or whether the ingestible product meets a labeling standard.
38. The method of clause 36 or 37, wherein the metric is determined using a trained machine learning model that was trained using a training dataset of historical data associated with the different steps of the production process.
39. The method of any one of clauses 36 to 38, wherein the data comprises one or more of: contaminant data indicating a level of a contaminant detected in the ingestible product, wherein the level of contaminant is usable to determine whether the ingestible product meets a safety standard; data indicating a characteristic of the ingestible product, wherein the characteristic of the ingestible product is usable to determine whether the ingestible product meets a quality standard; packaging data indicating a characteristic of packaging for the ingestible product, wherein the characteristic of the packaging is usable to determine whether the ingestible product meets a packaging standard; labeling data indicating a characteristic of labeling for the ingestible product, wherein the characteristic of the labeling is usable to determine whether the ingestible product meets a labeling standard; environmental data indicating a value of an environmental parameter associated with the facility that was detected as the different steps of the production process were carried out to produce the ingestible product; storage data indicating a storage condition of the ingestible product; or maintenance data indicating a maintenance action performed on processing equipment in the facility.
40. The method of any one of clauses 36 to 39, wherein the metric is determined after a final step of the production process is completed.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be used for realizing the disclosed techniques and systems in diverse forms thereof.

As will be understood by one of ordinary skill in the art, each implementation disclosed herein can comprise, consist essentially of or consist of its particular stated element, step, or component. Thus, the terms “include” or “including” should be interpreted to recite: “comprise, consist of, or consist essentially of.” The transition term “comprise” or “comprises” means has, but is not limited to, and allows for the inclusion of unspecified elements, steps, ingredients, or components, even in major amounts. The transitional phrase “consisting of” excludes any element, step, ingredient or component not specified. The transition phrase “consisting essentially of” limits the scope of the implementation to the specified elements, steps, ingredients or components and to those that do not materially affect the implementation. As used herein, the term “based on” is equivalent to “based at least partly on,” unless otherwise specified.

What is claimed is:

1. A method for determining whether a food product is ready to be released from a food processing facility where the food product is processed, the method comprising:
receiving data associated with different steps of a food production process carried out at the food processing facility to produce the food product;
determining, based at least in part on the data, a releasability metric associated with the food product, the releasability metric indicative of a probability of the food product being ready to be released from the food processing facility; and
causing information to be output via a user device based at least in part on the releasability metric, wherein the information indicates whether the food product is ready to be released from the food processing facility.

2. The method of claim 1, wherein the information further indicates one or more of:
whether the food product meets a safety standard;
whether the food product meets a quality standard;
whether the food product meets a packaging standard; or
whether the food product meets a labeling standard.

3. The method of claim 1, wherein the data comprises one or more of:
contaminant data indicating levels of contaminants detected in the food product, wherein the levels of contaminants are used to determine whether the food product meets a safety standard;
food data indicating characteristics of the food product, wherein the characteristics of the food product are used to determine whether the food product meets a quality standard;
packaging data indicating characteristics of packaging for the food product, wherein the characteristics of the packaging are used to determine whether the food product meets a packaging standard;
labeling data indicating characteristics of labeling for the food product, wherein the characteristics of the labeling are used to determine whether the food product meets a labeling standard;
environmental data indicating values of environmental parameters associated with the food processing facility that were detected as the different steps of the food production process were carried out to produce the food product;
storage data indicating storage conditions of the food product; or
maintenance data indicating maintenance actions performed on food processing equipment in the food processing facility.

4. The method of claim 1, wherein the data originated from devices distributed about the food processing facility.

5. A system comprising:
one or more processors; and
memory storing computer-executable instructions that, when executed by the one or more processors, cause performance of operations comprising:
receiving data associated with different steps of a food production process associated with a food product;
determining, based at least in part on the data, a metric associated with the food product, the metric indicative of a probability of the food product being ready to be released from a food processing facility; and
causing information to be output via a user device based at least in part on the metric, wherein the information indicates whether the food product is ready to be released from the food processing facility.

6. The system of claim 5, wherein the information further indicates one or more of:
whether the food product meets a safety standard;
whether the food product meets a quality standard;
whether the food product meets a packaging standard; or
whether the food product meets a labeling standard.

7. The system of claim 5, wherein the metric is determined using a trained machine learning model that was trained using a training dataset of historical data associated with the different steps of the food production process.

8. The system of claim 7, the operations further comprising:
receiving, from the user device, an indication of whether a user of the user device authorizes the food product to be released from the food processing facility; and
using the indication to retrain the trained machine learning model.

9. The system of claim 5, the operations further comprising:
determining that the metric fails to satisfy a threshold indicating that the food product is unlikely to be ready for release from the food processing facility,
wherein the information includes a recommendation for salvaging the food product.

10. The system of claim 9, wherein:
the food production process was carried out to produce the food product for a first end usage; and
the recommendation for salvaging the food product comprises a recommendation to redirect the food product to a second end usage different than the first end usage.

11. The system of claim 5, wherein the data comprises one or more of:
contaminant data indicating a level of a contaminant detected in the food product, wherein the level of contaminant is usable to determine whether the food product meets a safety standard;
food data indicating a characteristic of the food product, wherein the characteristic of the food product is usable to determine whether the food product meets a quality standard;
packaging data indicating a characteristic of packaging for the food product, wherein the characteristic of the packaging is usable to determine whether the food product meets a packaging standard;
labeling data indicating a characteristic of labeling for the food product, wherein the characteristic of the labeling is usable to determine whether the food product meets a labeling standard;
environmental data indicating a value of an environmental parameter associated with the food processing facility that was detected as the different steps of the food production process were carried out to produce the food product;
storage data indicating a storage condition of the food product; or
maintenance data indicating a maintenance action performed on food processing equipment in the food processing facility.

12. The system of claim 5, wherein the data originated from equipment distributed about the food processing facility.

13. The system of claim 5, wherein the metric is determined after a final step of the food production process is completed.

14. The system of claim 13, wherein the data is second data, and the metric is a second metric, the operations further comprising:
receiving first data associated with a raw food product delivered to the food processing facility, wherein the raw food product is usable for producing different food products including the food product;
determining, based at least in part on the first data, and prior to or during a first step of the food production process, first metrics associated with the different food products that are producible using the raw food product, wherein the first metrics are indicative of respective probabilities of the different food products being ready to be released from the food processing facility; and
designating the raw food product for use in producing the food product based at least in part on the first metrics.

15. The system of claim 14, wherein the first metrics and the second metric are determined using a trained machine learning model, the operations further comprising:
comparing the second metric with one of the first metrics that is associated with the food product; and
retraining the trained machine learning model based at least in part on the comparing.

16. A method comprising:
receiving data associated with different steps of a food production process associated with a food product;
determining, based at least in part on the data, a metric associated with the food product, the metric indicative of a probability of the food product being ready to be released from a food processing facility; and
causing information to be output via a user device based at least in part on the metric, wherein the information indicates whether the food product is ready to be released from the food processing facility.

17. The method of claim 16, wherein the information further indicates one or more of:
whether the food product meets a safety standard;
whether the food product meets a quality standard;
whether the food product meets a packaging standard; or
whether the food product meets a labeling standard.

18. The method of claim 16, wherein the metric is determined using a trained machine learning model that was trained using a training dataset of historical data associated with the different steps of the food production process.

19. The method of claim 16, wherein the data comprises one or more of:
contaminant data indicating a level of a contaminant detected in the food product, wherein the level of contaminant is usable to determine whether the food product meets a safety standard;
food data indicating a characteristic of the food product, wherein the characteristic of the food product is usable to determine whether the food product meets a quality standard;
packaging data indicating a characteristic of packaging for the food product, wherein the characteristic of the packaging is usable to determine whether the food product meets a packaging standard;
labeling data indicating a characteristic of labeling for the food product, wherein the characteristic of the labeling is usable to determine whether the food product meets a labeling standard;
environmental data indicating a value of an environmental parameter associated with the food processing facility that was detected as the different steps of the food production process were carried out to produce the food product;
storage data indicating a storage condition of the food product; or
maintenance data indicating a maintenance action performed on food processing equipment in the food processing facility.

20. The method of claim 16, wherein the metric is determined after a final step of the food production process is completed.
